(19) United States
(12) Patent Application Publication
(10) Pub. No.: US 2018/0215657 A1
(43) Pub. Date: Aug. 2, 2018

(54) TEXTURED GLASS SURFACES WITH LOW SPARKLE AND METHODS FOR MAKING SAME

(71) Applicant: CORNING INCORPORATED, Corning, NY (US)

(72) Inventor: Yuhui Jin, Painted Post, NY (US)

(21) Appl. No.: 15/879,716

(22) Filed: Jan. 25, 2018

Related U.S. Application Data
(60) Provisional application No. 62/452,042, filed on Jan. 30, 2017.

(51) Int. Cl. C03C 17/22; C03C 21/00; C03C 19/00

(52) U.S. Cl. CPC C03C 17/22; C03C 21/001; C03C 2204/08; C03C 2218/11; C03C 19/00

(57) ABSTRACT

A transparent glass sheet is disclosed that includes at least one anti-glare surface having a plurality of discrete surface features with an average size equal to or less than 20 microns and one or more flat regions. At least a portion of the discrete surface features are spaced apart from one another, and each of the plurality of discrete surface features may be bounded by the flat regions. The discrete surface features may be spaced apart and separated by the flat regions. The transparent glass sheet may have a sparkle value of equal to or less than 3% as evaluated by an SMS bench tester using a display light source of 141 ppi. A method for making the anti-glare surface on the transparent glass sheet is also disclosed that includes introducing the transparent glass sheet to a roughening solution and acid polishing the anti-glare surface.

### CROSS-REFERENCE TO RELATED APPLICATIONS

This application claims the benefit of priority under 35 U.S.C. § 119 of U.S. Provisional Application Ser. No. 62/452,042 filed on Jan. 30, 2017, the content of which is relied upon and incorporated herein by reference in its entirety.

### BACKGROUND

### Field

The present specification generally relates to textured glass, in particular textured glass for use as cover glass for display devices.

### Technical Background

Glass having a textured surface has been widely applied because of its functionality and aesthetic appearance. When incorporated into consumer electronic devices, textured cover glass may effectively reduce the surface glare and improve the tactile feeling of the device, in particular for touch screen devices. However, the presence of the textured surface on the cover glass has been shown to cause various modes of image distortion which can degrade the performance of a high definition display.

### SUMMARY

Accordingly, a need exists for glass having a textured surface with reduced distortion, known as sparkle, and for methods for making the textured glass.

In an embodiment, a transparent glass sheet includes at least one anti-glare surface having a plurality of discrete surface features having an average size equal to or less than 20 microns and one or more flat regions. At least a portion of the plurality of discrete surface features are spaced apart from one another, and each of the plurality of discrete surface features are bounded by the one or more flat regions. The transparent glass sheet has a sparkle of equal to or less than 3% as evaluated by an SMS bench tester using a display light source of 141 ppi.

In another embodiment, a method for producing an anti-glare surface treatment on a transparent glass sheet includes introducing a roughening solution to a surface of the transparent glass sheet. The roughening solution includes from 1 wt. % to 6 wt. % hydrofluoric acid, from 5 wt. % to 15 wt. % ammonium fluoride, from 2 wt. % to 20 wt. % potassium chloride. The method further includes maintaining the roughening solution in contact with the surface of the transparent glass sheet to form and grow a plurality of surface features on the surface of the transparent glass sheet, and removing the roughening solution from contact with the surface of the transparent glass sheet before the plurality of surface features grow to fill the entire surface of the transparent glass sheet, wherein upon removal of the roughening solution, the transparent glass sheet has a plurality of discrete surface features separated from one another by one or more flat regions.

It is to be understood that both the foregoing general description and the following detailed description describe various embodiments and are intended to provide an overview or framework for understanding the nature and character of the claimed subject matter. The accompanying drawings are included to provide a further understanding of the various embodiments, and are incorporated into and constitute a part of this specification. The drawings illustrate the various embodiments described herein, and together with the description serve to explain the principles and operations of the claimed subject matter.

### BRIEF DESCRIPTION OF THE DRAWINGS

FIG. 1A schematically depicts a transparent glass sheet having a conventional anti-glare surface;

FIG. 1B schematically depicts a transparent glass sheet having another conventional anti-glare surface;

FIG. 2A schematically depicts an example transparent glass sheet with an anti-glare surface having a plurality of discrete surface features protruding from the transparent glass sheet, according to one or more embodiments as shown and described herein;

FIG. 2B schematically depicts another example transparent glass sheet with another anti-glare surface having a plurality of discrete surface features recessed into the transparent glass sheet, according to one or more embodiments as shown and described herein;

FIG. 3 schematically depicts a top view of the transparent glass sheet of FIG. 2A, according to one or more embodiments as shown and described herein;

FIG. 4 is a photomicrograph taken at 200× magnification of an example transparent glass sheet having the conventional anti-glare surface of FIG. 1A;

FIG. 5 is a photomicrograph taken at 200× magnification of another example transparent glass sheet having the conventional anti-glare surface of FIG. 1A;

FIG. 6 is a photomicrograph taken at 200× magnification of an example transparent glass sheet having the anti-glare surface of FIG. 2A having a plurality of discrete surface features, according to one or more embodiments as shown and described herein;

FIG. 7 is a photomicrograph taken at 200× magnification of another example transparent glass sheet with the anti-glare surface of FIG. 2A having a plurality of discrete surface features, according to one or more embodiments as shown and described herein;

FIG. 8 is a flow chart of a method for forming a transparent glass sheet with the anti-glare surface of FIG. 2A having a plurality of discrete surface features, according to one or more embodiments as shown and described herein;

FIGS. 9A-9D schematically depict formation of the conventional anti-glare surface of FIG. 1A on a glass sheet;

FIGS. 10A-10D schematically depict formation of the anti-glare surface of FIG. 2A having a plurality of discrete surface features on a transparent glass sheet using the method of FIG. 8, according to one or more embodiments as shown and described herein;

FIGS. 11-26 are photomicrographs taken at 200× magnification of example transparent glass sheets having the anti-glare surfaces with a plurality of discrete surface features made by the method depicted in FIG. 8, according to one or more embodiments as shown and described herein;

FIG. 27 is a plot of sparkle (y-axis) as a function of transmission haze (x-axis) for glass sheets having the conventional anti-glare surface schematically depicted in FIG. 1A and for transparent glass sheets having the anti-glare surfaces of FIG. 2A with discrete surface features, according to one or more embodiments as shown and described herein; and

FIG. 28 is a photomicrograph taken at 500× magnification of a transparent glass sheet having the anti-glare surface of FIG. 2A having a plurality of discrete surface features made by the method of FIG. 8, according to one or more embodiments as shown and described herein.

### DETAILED DESCRIPTION

Reference will now be made in detail to embodiments of transparent glass sheets having anti-glare surfaces having low sparkle and methods of making the anti-glare surface having low sparkle, examples of which are illustrated in the accompanying drawings. Whenever possible, the same reference numerals will be used throughout the drawings to refer to the same or like parts.

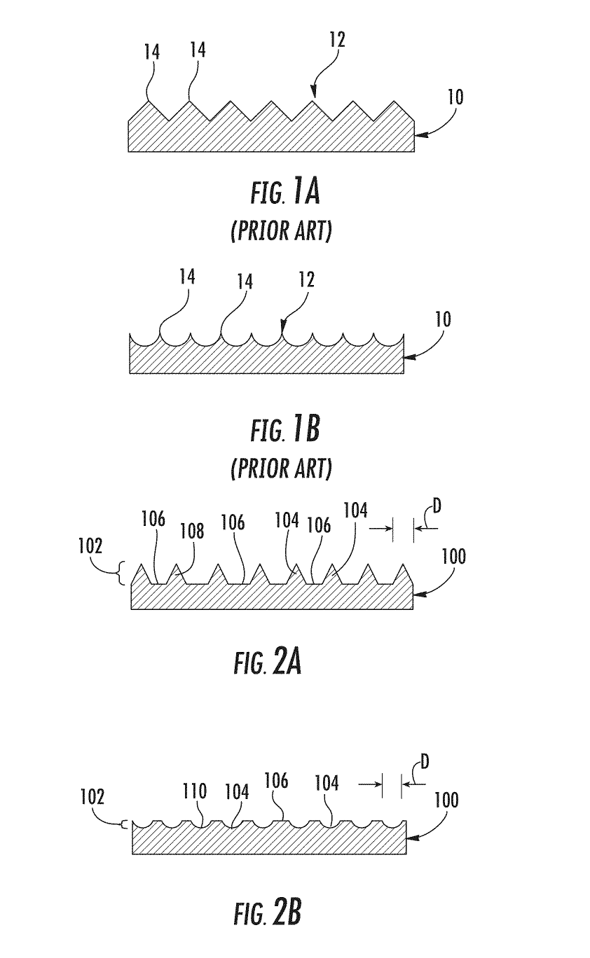

One embodiment of an example transparent glass sheet 100 is schematically depicted in FIG. 2A. The example transparent glass sheet 100 of FIG. 2A comprises an anti-glare surface 102 having a plurality of discrete surface features 104 and one or more flat regions 106. The discrete surface features 104 have an average size of less than 20 microns, or alternatively less than 10 microns. At least a portion of the plurality of discrete surface features 104 are spaced apart from one another, and each of the plurality of discrete surface features 104 are bounded by the one or more flat regions 106. The transparent glass sheet 100 of FIG. 2 with the anti-glare surface 102 having a plurality of discrete surface features 104 may have a sparkle value of equal to or less than 3% as evaluated by an SMS bench tester using a display light source of 141 pixels per inch (ppi). The anti-glare surface 102 having discrete surface features 104, which may be spaced apart and separated by one or more flat regions 106, results in a combination of curved surfaces and flat surfaces. Because the flat surfaces do not contribute to sparkle, the overall sparkle value for the anti-glare surface 102 having discrete surface features 104 spaced apart by flat regions may be reduced compared to the conventional anti-glare surfaces 12 (FIG. 1A), which have continuous surface features 14 that provide a continuously curved surface.

Directional terms as used herein, such as up, down, right, left, front, back, top, bottom, are made only with reference to the figures as drawn and are not intended to imply absolute orientation.

Unless otherwise expressly stated, it is in no way intended that any method set forth herein be construed as requiring that its steps be performed in a specific order, nor that specific orientations be required with any apparatus. Accordingly, where a method claim does not actually recite an order to be followed by its steps, or that any apparatus claim does not actually recite an order or orientation to individual components, or it is not otherwise specifically stated in the claims or description that the steps are to be limited to a specific order, or that a specific order or orientation to components of an apparatus is not recited, it is in no way intended that an order or orientation be inferred, in any respect. This holds for any possible non-express basis for interpretation, including: matters of logic with respect to arrangement of steps, operational flow, order of components, or orientation of components; plain meaning derived from grammatical organization or punctuation, and; the number or type of embodiments described in the specification.

As used herein, the singular forms “a,” “an” and “the” include plural referents unless the context clearly dictates otherwise. Thus, for example, reference to “a” component includes aspects having two or more such components, unless the context clearly indicates otherwise.

Display “sparkle” or “dazzle” is a generally undesirable side effect that can occur when introducing anti-glare or light scattering surfaces into a pixelated display system such as, for example, a liquid crystal display (LCD), an organic light emitting diode (OLED), touch screens, or the like, and differs in type and origin from the type of “sparkle” or “speckle” that has been observed and characterized in projection or laser systems. Sparkle is associated with a very fine grainy appearance of the display, and may appear to have a shift in the pattern of the grains with changing viewing angle of the display. Display sparkle may be manifested as bright and dark or colored spots at approximately the pixel-level size scale.

Whereas the most common anti-glare surfaces used in the display industry are coated polymer films, the present disclosure is primarily concerned with the optical and surface properties of a transparent glass article or sheet that is used as a protective cover glass over an LCD or other pixelated displays. In particular, a transparent glass sheet having a roughened surface and optical properties that minimize display “sparkle” and a display system comprising such a transparent glass sheet are provided. Additionally, surfaces with preferred small-angle-scattering properties or distinctness-of-reflected-image (DOI) which lead to improved viewability in display applications, especially under high ambient lighting conditions, are provided. The anti-glare surface is formed without the application or other use of foreign coating materials (e.g., coatings, films, or the like).

The origin of display sparkle has previously not been well understood. There are many potential root causes that could be hypothesized, such as interference effects, Rayleigh or Mie-type scattering, and the like. As described herein, it has been determined that the type of display sparkle that is commonly observed in pixelated displays combined with anti-glare surfaces is primarily a refractive effect in which features have some macroscopic (i.e., much larger than optical wavelength) dimensions on the surface, which cause refraction or “lensing” of display pixels into varying angles, thus modifying the apparent relative intensity of the pixels.

Referring to FIGS. 1A-1B, glass sheets 10 having conventional anti-glare surfaces 12 are depicted, with FIG. 1A illustrating a conventional anti-glare surface 12 comprising a plurality of protrusions and FIG. 1B illustrating a conventional anti-glare surface 12 comprising a plurality of depressions. Conventional anti-glare surfaces 12 seek to minimize sparkle by controlling the roughness profile of a continuously textured surface. However, these conventional anti-glare surfaces 12 have continuous surface features 14 that completely cover the glass surface in a continuous textured layer. In both of FIGS. 1A and 1B, the surface features 14 (i.e., the protrusions of FIG. 1A or depressions of FIG. 1B) of the conventional anti-glare surface 12 are continuously distributed across the entire surface of the glass sheet 10. Because of this, the conventional anti-glare surfaces 12 have continuously curved surfaces with no flat areas in between the curved surfaces. The continuously curved surfaces are not ideal for low sparkle applications because of their contribution to the “lensing” effect described above.

Referring now to FIGS. 2A-2B, the transparent glass sheet 100 is disclosed that includes an anti-glare surface 102 having a plurality of discrete surface features 104 and one or more flat regions 106. The discrete surface features 104 are spaced apart from one another and the flat regions 106 generally extend between each of the discrete surface features 104. The resulting anti-glare surface 102 includes a plurality of curved surfaces distributed across a flat surface so that the anti-glare surface 102 is a mixture of flat and curved surfaces. The distribution of discrete surface features 104 across the flat surface may provide anti-glare properties and acceptable aesthetic appearance and feel while at the same time providing a low sparkle glass.

The transparent glass sheet 100 may be a soda lime glass, an alkali aluminosilicate glass, or an alkali aluminoborosilicate glass. As used herein, the glass is transparent if it transmits at least 70% of at least one wavelength in a range from 390 nm to 700 nm. In some embodiments, the transparent glass sheet 100 may comprise an alkali aluminosilicate glass that includes alumina, at least one alkali metal, and silica (SiO₂). An amount of silica the transparent glass sheet 100 may be greater than 50 mol %, at least 58 mol % SiO₂, or at least 60 mol % SiO₂. Examples of aluminosilicate glass substrates suitable for use as the transparent glass sheet 100 may include, but are not limited to, GORILLA®, EAGLE XG®, or LOTUS™ brand glass manufactured by Corning Incorporated. Other suitable substrates are contemplated. The transparent glass sheet 100 may include a strengthened glass substrate, which has been strengthened using thermal or chemical strengthening techniques.

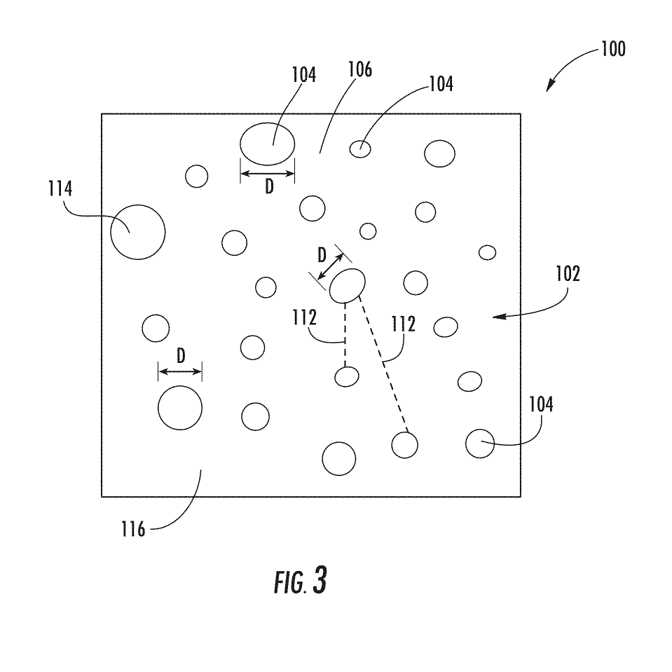

The discrete surface features 104 of the anti-glare surface 102 of the transparent glass sheet 100 may be protrusions 108 that extend outward from the transparent glass sheet 100, as shown in FIG. 2A. Alternatively, the discrete surface features 104 may be depressions 110 that are recessed into the transparent glass sheet 100, as shown in FIG. 2B. FIG. 3 schematically depicts a top view of either of the example transparent glass sheets 100 of FIGS. 2A and 2B. As schematically depicted in FIG. 3, the size of each of the discrete surface features 104 is defined as the largest dimension D of the discrete surface feature 104 when the discrete surface feature 104 is viewed from a direction perpendicular to the anti-glare surface 102 of the transparent glass sheet 100 (i.e., in top view). An average size of the discrete surface features 104 of the anti-glare surface 102 may be less than 20 microns, less than 10 microns, or less than 5 microns. Alternatively, each of the discrete surface features 104 may have a largest dimension D that is equal to or less than 20 microns, equal to or less than 10 microns, or equal to or less than 5 microns. The discrete surface features 104 may have a lesser average size than the continuous surface features 14 of conventional anti-glare surfaces 12 (e.g., as depicted in FIGS. 1A and 1B). The reduced average size of the discrete surface features 104 reduces the sparkle value of the anti-glare surface 102 having the plurality of discrete surface features 104 compared to conventional anti-glare surfaces 12 (FIG. 1A).

Referring to FIG. 3, the discrete surface features 104 are discrete, meaning that the discrete surface features 104 are not continuous across the anti-glare surface 102. Accordingly, the discrete surface features 104 are not interconnected with one another. Instead, the discrete surface features 104 are spaced apart from each other so that one or more flat regions 106 are positioned in between each adjacent discrete surface feature 104. As used herein, a flat region is a region of the surface void of discrete surface features having a largest dimension greater than or equal to 1 micron. For example, each of the discrete surface features 104 is isolated from each of the other discrete surface features 104. Each of the discrete surface features 104 are separated from each of the other discrete surface features 104 by the flat regions 106. Alternatively, at least a portion of the discrete surface features 104 may be spaced apart from each of the other discrete surface features 104 and separated from each of the other discrete surface features 104 by the flat regions 106. In another alternative example, a majority of the discrete surface features 104 are spaced apart from the other discrete surface features 104 and separated from the other discrete surface features 104 by the flat regions 106. Optionally, at least a portion of the discrete surface features 104 may be circumscribed by the flat regions 106 (i.e., completely surrounded or encircled by the flat regions 106).

As described above, one or more flat regions 106 occupy the space between each of the discrete surface features 104. Additionally, the flat regions 106 are contiguous such that each flat region 106 is connected with one or more other flat regions 106 that extend around one or more other discrete surface features 104. For example, the flat regions 106 are interconnected so that the flat regions 106 form a contiguous flat region, which may form a contiguous network or matrix of flat regions 106. In this manner, the anti-glare surface 102 includes a flat surface over which the discrete surface features 104 are distributed at individual, spaced-apart positions. The flat regions 106 propagate across the entire anti-glare surface 102 in an interconnected two-dimensional irregular-shaped lattice and are not isolated in discrete pockets completely surrounded by discrete surface features 104. The flat regions 106 may be continuously interconnected across the entirety of the anti-glare surface 102.

Referring to FIG. 3, the flat regions 106 extend between each of the discrete surface features 104 so that a line 112 in the plane of the flat regions 106 of the anti-glare surface 102 extending from any one discrete surface feature 104 to any other discrete surface feature 104 passes through one or more flat regions 106. An area of the flat regions 106 may be from 10% to 60%, from 10% to 50%, from 15% to 60%, or from 15% to 50% of the total surface area of the anti-glare surface 102. In a non-limiting example, the area of the flat regions 106 may be from 10% to 60% of the total surface area of the anti-glare surface 102. Alternatively, the area of the flat regions 106 may be from 15% to 50% of the total surface area of the anti-glare surface 102.

As described previously, the anti-glare surface 102 having discrete surface features 104, which may be spaced apart and separated by one or more flat regions 106, may be a combination of curved surfaces 114 and flat surfaces 116. Because the flat surfaces 116 do not contribute to sparkle, the overall sparkle value for the anti-glare surface 102 having discrete surface features 104 may be reduced as compared to the conventional anti-glare surface 12 having continuous surface features 14, which results in a continuously curved surface.

The transparent glass sheet 100 having the anti-glare surface 102 with the plurality of discrete surface features 104, as previously described, may have a sparkle value of less than 3%, or less than 2%. As used herein, the sparkle value of the transparent glass sheet 100 is evaluated using SMS Bench and a display light source of 141 ppi, unless otherwise indicated. The anti-glare surface 102 having the discrete surface features 104 may have an average surface roughness (Ra) of from 10 nanometers (nm) to 1000 nm, or from 10 nm to 200 nm. Additionally, the anti-glare surface 102 having the discrete surface features 104 may have a transmission haze value of equal to or less than 20% as measured in accordance with ASTM D1003 using a Haze-Guard transmittance and haze testing apparatus obtained from Elektron Technologies, PLC.

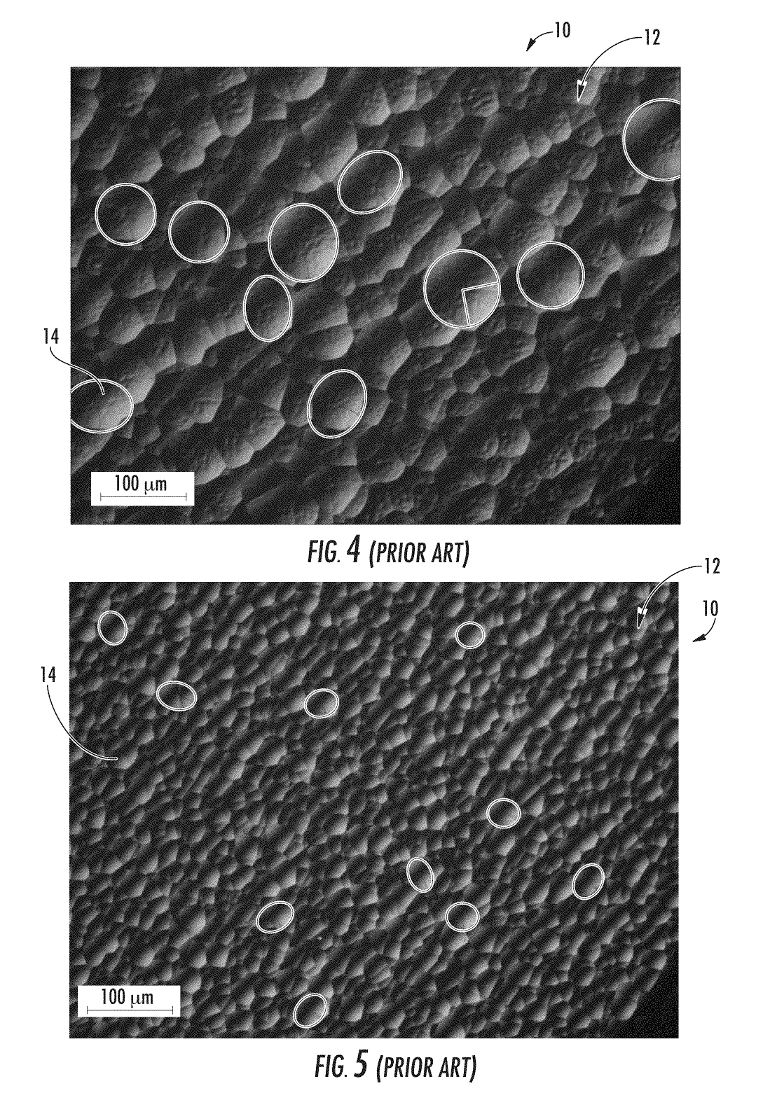

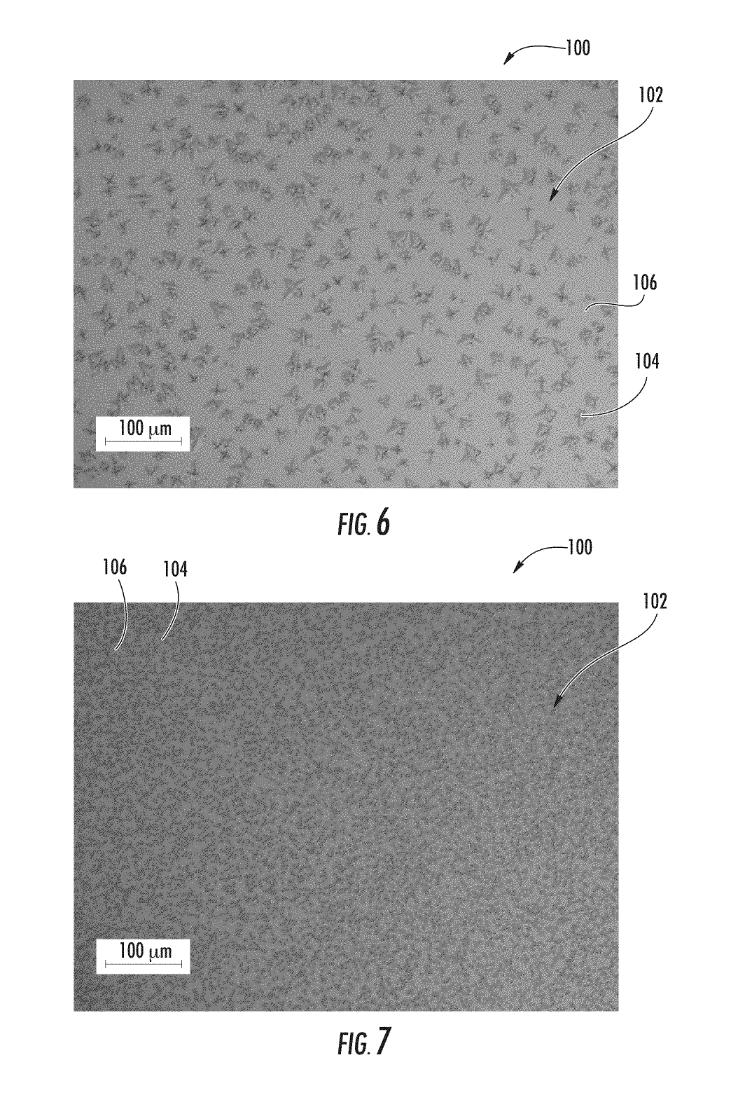

As shown in FIGS. 1A and 1B, for conventional anti-glare surfaces 12, the surface features 14 are all interconnected in a continuous texture, and no flat regions 106 are interspersed between the surface features 14. The continuous distribution of the surface features 14 of conventional anti-glare surfaces 12 are further depicted in FIGS. 4 and 5, which are photomicrographs of two different conventional anti-glare surfaces 12 having different surface roughness (i.e., different size surface features 14). As shown in FIGS. 4 and 5, the surface features 14 are distributed continuously over the conventional anti-glare surface 12 so that each surface feature 14 is connected to and/or abuts up against each immediately adjacent surface feature 14 with no intervening flat areas and no interruption in the continuity of the continuous textured layer.

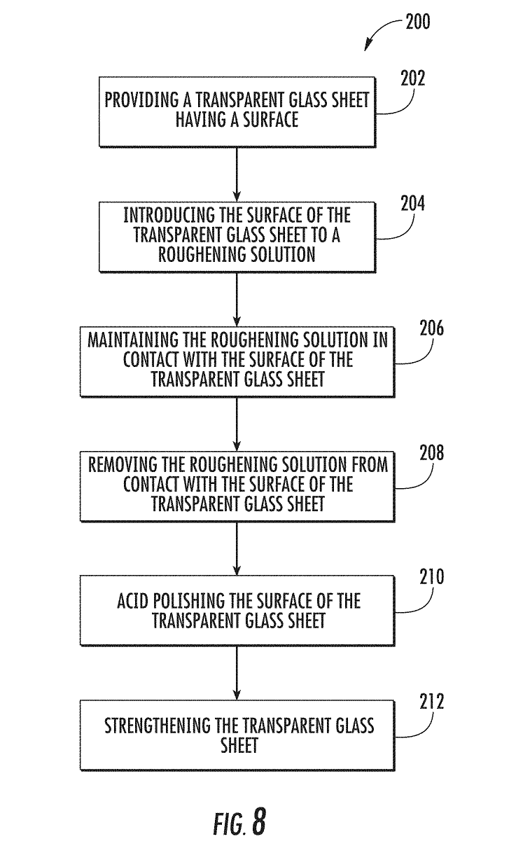

In contrast, as shown in FIGS. 2A, 2B, and 3 for the anti-glare surface 102 of the present disclosure, the discrete surface features 104 are grown on the surface of the transparent glass sheet 100 in a discrete manner to produce the anti-glare surface 102 that is a combination of curved surfaces 114 (i.e., the discrete surface features 104) and flat surfaces 116 (i.e., the flat regions 106). This combination of curved surfaces 114 and flat surfaces 116 is shown in FIGS. 6 and 7, which are 200× photomicrographs of anti-glare surfaces 102 having the plurality of discrete surface features 104 separated by flat regions 106 as previously described. As shown in FIGS. 6 and 7, each of the discrete surface features 104 are spaced apart from one another with the flat regions 106 extending between each of the discrete surface features 104. The anti-glare surface 102 in FIG. 6 has discrete surface features 104 that are larger and fewer in number (i.e., lesser discrete feature density) compared to the discrete surface features 104 shown in FIG. 7, which are smaller and greater in number (i.e., greater discrete feature density).

The transparent glass sheet 100 having the anti-glare surface 102 that includes the plurality of discrete surface features 104 separated by the flat regions 106 may be compatible with high definition (HD) displays having pixel densities of 200 ppi or greater. The ability to provide a low sparkle textured glass, such as transparent glass sheet 100, that is compatible with HD displays having high pixel density may create opportunities for integrating textured surfaces with consumer electronic devices. The transparent glass sheet 100 having such an anti-glare surface 102 may provide a glass with low sparkle that exhibits positive aesthetic appearance, good tactile feel, and anti-glare functionality.

In one or more embodiments, the discrete surface features 104 that protrude from the transparent glass sheet 100 may be made by a chemical etching method. Referring to FIG. 8, a method 200 for producing an anti-glare surface on a transparent glass sheet includes providing 202 the transparent glass sheet 100 having a surface 101. The transparent glass sheet 100 may be any of the transparent glass sheets previously described. The method 200 further includes introducing 204 the surface 101 of the transparent glass sheet 100 to a roughening solution. The composition of the roughening solution is subsequently described. In an example method 200, the transparent glass sheet 100 may be introduced to a bath of the roughening solution. The method 200 further includes maintaining 206 the roughening solution in contact with the surface 101 of the transparent glass sheet 100 to form the plurality of discrete surface features 104 on the surface 101 of the transparent glass sheet 100. In embodiments, the surface 101 of the transparent glass sheet 100 is maintained in contact with the roughening solution for a reaction time equal to or greater than 1 minute and equal to or less than 8 minutes. Alternatively, the reaction time may be equal to or greater than 1 minute or equal to or less than 4 minutes.

The method 200 includes removing 208 the roughening solution from contact with the surface 101 of the transparent glass sheet 100 before the plurality of discrete surface features 104 grow to fill the entire surface 101 of the transparent glass sheet 100. Upon removal of the roughening solution, the transparent glass sheet 100 comprises the plurality of discrete surface features 104 separated from one another by one or more flat regions 106. The method 200 may also include acid polishing 210 the surface 101 of the transparent glass sheet 100 to reduce a transmission haze of the transparent glass sheet 100 and a size of the plurality of discrete surface features 104.

The method 200 may optionally include strengthening 212 the transparent glass sheet 100. As previously described, the transparent glass sheet 100 may be thermally strengthened or chemically strengthened 212. The method 200 may optionally include cleaning (not shown) the surface 101 of the transparent glass sheet 100 prior to introducing the roughening solution to the surface 101 of the transparent glass sheet 100. The method 200 may also optionally include rinsing or cleaning (not shown) the surface 101 of the transparent glass sheet after the acid polishing 210 step or between removing 208 the roughening solution from the surface 101 of the transparent glass sheet 100 and acid polishing 210 the surface 101 of the transparent glass sheet 100.

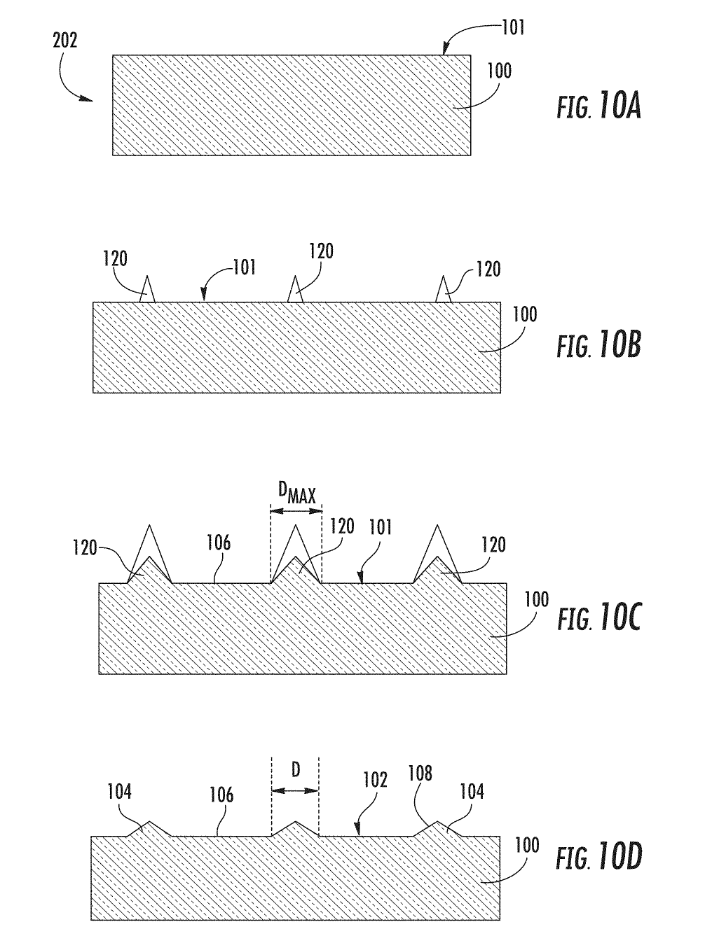

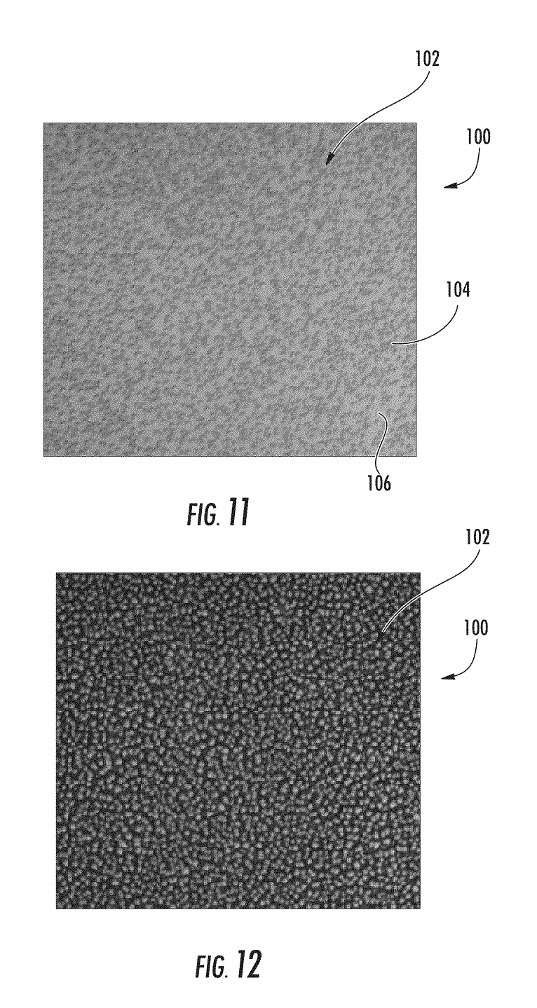

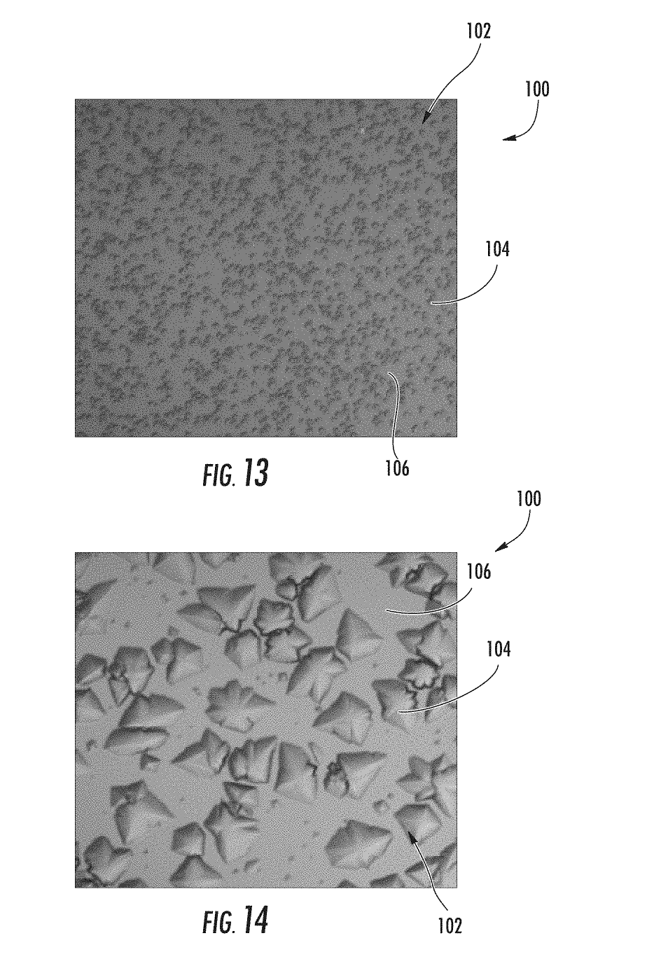

Referring to FIGS. 10A-10D, the formation, growth, and acid polishing of the discrete surface features 104 that occur during the method 200 of FIG. 8 will be described in further detail. FIG. 10A schematically depicts the transparent glass sheet 100, which has surface 101, prior to introducing 204 the roughening solution to the surface 101 of the transparent glass sheet 100. FIGS. 10B and 10C schematically depict the formation and growth of crystals 120 on the surface 101 of the transparent glass sheet 100. The formation and growth of the crystals 120 occur while maintaining the roughening solution in contact with the surface 101 of the transparent glass sheet 100. The crystals 120 ultimately form the discrete surface features 104. Referring to FIG. 10B, once the roughening solution is introduced to the surface 101 of the transparent glass sheet 100 in the introducing 204 step of the method 200, the roughening solution causes crystals 120 to form on the surface 101 of the transparent glass sheet 100. The crystals 120 are spaced apart and separated by flat regions 106 of the surface 101 of the transparent glass sheet 100. Formation of the crystals 120 occurs through precipitation of a solid reaction product on the surface 101 of the transparent glass sheet 100. The composition of the crystals 120 and chemical reactions leading to precipitation of the crystals 120 will be described in more detail subsequently.

Referring to FIG. 10C and FIG. 8, the crystals 120 are then grown through maintaining 206 the roughening solution in contact with the surface 101 of the transparent glass sheet 100. During crystal growth, the crystals 120, which are seeded on the surface 101 of the transparent glass sheet 100, are gown in size to increase the surface roughness of the anti-glare surface 102. As shown in FIG. 10C, the crystals 120 grow to a maximum size D_{MAX} by the end of the maintaining 206 step. FIG. 10D schematically depicts the transparent glass sheet 100 after the acid polishing 210 step of the method 200. During acid polishing 210, the anti-glare surface 102 of the transparent glass sheet 100 having the plurality of crystals 120 formed and grown thereon is chemically etched, which reduces the haze of the anti-glare surface 102 and may reduce the size (i.e., largest dimension D) of the crystals 120 to form the discrete surface features 104, which are separated by the flat regions 106.

The formation and growth of the crystals 120 to form the discrete surface features 104 are controlled so that the discrete surface features 104 remain spaced apart and separated from one another by flat regions 106. Crystal formation may be controlled to control the density of the discrete surface features 104 on the surface 101 of the transparent glass sheet 100 so that the discrete surface features 104 are maintained spaced apart and separated by the flat regions 106 of the glass surface 101 extending between each of the discrete surface features 104. Crystal growth may be controlled to limit the average size of the discrete surface features 104 to prevent them from growing into each other to create a continuous array of surface features. Forming and growing the crystals 120, which become the discrete surface features 104, may be conducted simultaneously. For example, the roughening solution may promote both formation and growth of the crystals 120 (i.e., discrete surface features 104) on the surface 101 of the transparent glass sheet 100.

The roughening solution may include hydrofluoric acid, one or more roughening reagents, and a solvent. In embodiments, the roughening solution may include a weight percent (wt. %) of hydrofluoric acid (HF) of from 0.5 wt. % to 10 wt. %, from 0.5 wt. % to 6 wt. %, from 0.5 wt. % to 3 wt. %, from 0.5 wt. % to 1 wt. %, from 1 wt. % to 10 wt. %, from 1 wt. % to 6 wt. %, from 1 wt. % to 3 wt. %, from 3 wt. % to 10 wt. %, from 3 wt. % to 6 wt. %, or from 6 wt. % to 10 wt. %. In some non-limiting examples, the roughening solution may include from 1 wt. % to 8 wt. % hydrofluoric acid. Alternatively, the roughening solution may include from 1 wt. % to 6 wt. % hydrofluoric acid.

The roughening reagent may be a reagent or combination of reagents that promote crystal formation and crystal growth by providing the cations (M⁺) to the roughening solution. The roughening reagent may include one or more inorganic salts containing potassium, sodium, and/or ammonium ions or combinations of ions. Non-limiting examples of roughening reagents may include, but are not limited to, potassium chloride (KCl), potassium nitrate (KNO₃), potassium sulfate (K₂SO₄), sodium chloride (NaCl), sodium nitrate (NaNO₃), sodium sulfate (Na₂SO₄), ammonium fluoride (NH₄F), ammonium chloride (NH₄Cl), ammonium nitrate (NH₄NO₃), ammonium sulfate ((NH₄)₂SO₄), other inorganic salts, and combinations of inorganic salts. In some non-limiting examples, the roughening solution may include a plurality of roughening reagents. For example, the roughening solution may include ammonium fluoride and potassium chloride as the roughening reagents.

The roughening solution may have a weight percent of a single roughening reagent of from 2 wt. % to 20 wt. %, from 2 wt. % to 15 wt. %, from 2 wt. % to 10 wt. %, from 2 wt. % to 5 wt. %, from 5 wt. % to 20 wt. %, from 5 wt. % to 15 wt. %, from 5 wt. % to 10 wt. %, from 10 wt. % to 20 wt. %, from 10 wt. % to 15 wt. %, or from 15 wt. % to 20 wt. %. The roughening solution may have a total weight percent (wt. %) of the roughening reagent, including multiple roughening reagents, of from 5 wt. % to 35 wt. %, from 5 wt. % to 25 wt. %, from 5 wt. % to 20 wt. %, from 5 wt. % to 17 wt. %, from 5 wt. % to 15 wt. %, from 7 wt. % to 35 wt. %, from 7 wt. % to 25 wt. %, from 7 wt. % to 20 wt. %, from 7 wt. % to 17 wt. %, from 7 wt. % to 15 wt. %, from 15 wt. % to 35 wt. %, from 15 wt. % to 25 wt. %, from 15 wt. % to 20 wt. %, from 15 wt. % to 17 wt. %, from 17 wt. % to 35 wt. %, from 17 wt. % to 25 wt. %, from 17 wt. % to 20 wt. %, from 20 wt. % to 35 wt. %, or from 20 wt. % to 25 wt. %. In some non-limiting examples, the roughening solution may include a weight percent of NH₄F of from 5 wt. % to 15 wt. % and a concentration of KCl of from 2 wt. % to 20 wt. %. Alternatively, the roughening solution may have a weight percent of NH₄F of from 10 wt. % to 20 wt. %.

The solvent may include water, which may make up the balance of the solution. The solvent may optionally include an organic solvent. Examples of suitable organic solvents may include, but are not limited to, polyols, such as a propylene glycol for example; alcohols, such as ethanol for example; and/or water miscible polar organic solvents, such as acetic acid for example. In some non-limiting examples, the roughening solution may include propylene glycol. The volume percent (vol. %) of propylene glycol in the roughening solution may be from 1 vol. % to 20 vol. %, from 1 vol. % to 15 vol. %, from 1 vol. % to 10 vol. %, from 1 vol. % to 5 vol. %, from 5 vol. % to 20 vol. %, from 5 vol. % to 15 vol. %, from 5 vol. % to 10 vol. %, from 10 vol. % to 20 vol. %, from 10 vol. % to 15 vol. %, or from 15 vol. % to 20 vol. %. Alternatively, the roughening solution may be substantially free of an organic solvent. As used in this disclosure, “substantially free” of a component means less than 1 wt. % of that component in a particular composition. As an example, a roughening solution which is substantially free of an organic solvent may have less than 1 wt. % of ethylene. Example roughening solutions may include one or more other additives, such as a surfactant, for example. An example roughening solution may have 1 wt. % or less of the surfactant.

In one or more non-limiting examples, the roughening solution may comprise, consist essentially of, or consist of HF, NH₄F, KCl, and water. More specifically, the roughening solution may comprise, consist essentially of, or consist of from 1 wt. % to 6 wt. % HF, from 10 wt. % to 20 wt. % NH₄F, from 2 wt. % to 20 wt. % KCl, and water. Alternatively, the roughening solution may comprise, consist essentially of, or consist of from 1 wt. % to 6 wt. % HF, from 5 wt. % to 15 wt. % NH₄F, from 2 wt. % to 20 wt. % KCl, and water. In other non-limiting examples, the roughening solution may comprise, consist essentially of, or consist of from 1 wt. % to 6 wt. % HF, from 10 wt. % to 20 wt. % NH₄F, from 2 wt. % to 20 wt. % KCl, from 1 vol. % to 15 vol. % propylene glycol, and the balance water.

While the transparent glass sheet 100 is exposed to the roughening solution, crystal seeds are formed on the surface of the transparent glass sheet 100 and grow according to the following chemical equations:

6HF+SiO₂→H₂SiF₆+2H₂O Eq. 1

2M⁺+SiF₆²⁻→M₂SiF₆↓; where M=K⁺,Na⁺,NH₄⁺,etc. Eq. 2

In equation 1, hydrofluoric acid (HF) reacts with the silica (SiO₂) of the glass to produce a fluorosilicate (H₂SiF₆) and water. The H₂SiF₆ may dissociate in water, and the SiF₆²⁻ ions may reacts with a cation (M) provided by the roughening reagent to produce the M₂SiF₆, per equation 2. The M₂SiF₆ precipitates on the surface of the transparent glass sheet 100 to form and grow the crystals, which become the discrete surface features 104. As previously discussed, the cation M provided by the roughening reagent may be a metal ion, such as potassium ion (K⁺) or sodium ion (Na⁺) for example, or the cation M may be a non-metallic cation, such as ammonium ion (NH₄⁺) for example.

The discrete surface features 104, which are small in size and separated from one another by interconnected flat regions 106, are made by controlling crystal formation 204 and/or crystal growth 206 during the roughening process. Limiting crystal formation 204 to reduce the crystal seed density may ensure the formation of discrete surface features 104 that are spaced apart from one another and separated by flat regions 106 rather than a continuous interconnected network of surface features. Limiting growth 206 of the crystals 210 may prevent individual crystals 210 from growing into one another and combining to bridge the gaps between the discrete surface features 104. Further, controlling crystal growth may ensure that the surface features are appropriately sized to provide a target surface roughness. The composition of the roughening solution, temperature of the roughening solution, and reaction time of the transparent glass sheet 100 with the roughening solution may all be manipulated to control the crystal formation and crystal growth on the glass surface. The reaction time is the time period over which the transparent glass sheet 100 is maintained in contact with the roughening solution.

Tuning the composition of the roughening solution can effectively control the surface seed density (i.e., crystal formation density) and crystal growth rate. The number of crystal seeds that form on the surface 101 of the transparent glass sheet 100 may be controlled by controlling the concentration of the roughening reagents in the roughening solution. Increasing the concentration of the roughening reagents increases the concentration of cations (e.g., K⁺, Na⁺, NH₄⁺, etc.), which drives the reaction of Equation 2 to the right in favor of producing more M₂SiF₆. Increasing the concentration of M₂SiF₆ through production of more M₂SiF₆ results in increased precipitation of M₂SiF₆ and, thus, an increase in the number of seeds formed on the glass surface 101. Likewise, decreasing the concentration of the roughening reagents drive the reaction of Equation 2 to the left in favor of decreasing concentration of M₂SiF₆, which leads to fewer seed formed on the glass surface 101. Therefore, the number of crystals formed (i.e., seeds formed) on the glass surface 101 may be reduced by reducing the concentration of the roughening reagents in the roughening solution.

Additionally, initial crystal formation on the glass surface 101 may be controlled by manipulating the solubility of the M₂SiF₆ in the roughening solution, which may be accomplished by changing the temperature of the roughening solution or changing the concentration of organic solvents in the roughening solution. For example, decreasing the temperature of the roughening solution decreases the solubility of M₂SiF₆ in the roughening solution, which results in increased precipitation of the M₂SiF₆ and increased crystal formation on the glass surface 101. Conversely, increasing the temperature of the roughening solution increases the solubility of M₂SiF₆ in the roughening solution and decreases precipitation of M₂SiF₆, which reduces formation of crystals on the glass surface 101. Therefore, decreasing the temperature increases crystal formation, which results in a greater density of the discrete surface features 104 on the surface 101 of the transparent glass sheet 100. The roughening solution may be maintained at a temperature of from 10° C. to 40° C. In some non-limiting examples, the roughening solution may be maintained at room temperature, which may be from 20° C. to 30° C.

Increasing the concentration of organic solvent in the roughening solution also tends to decrease the solubility of M₂SiF₆ in the roughening solution, leading to increased crystal formation. Conversely, decreasing the concentration of organic solvents in the roughening solution may tend to reduce crystal formation on the glass surface 101. Crystal formation may be reduced, and therefore limited, by maintaining a reduced concentration of the roughening reagents in the roughening solution, maintaining a higher temperature of the roughening solution, and/or reducing the concentration of organic solvents in the roughening solution. Alternatively, increasing the concentration of organic solvent in the roughening solution may increase crystal formation, resulting in a greater density of discrete surface features 104 formed on the surface 101 of the transparent glass sheet 100.

Crystal growth may be controlled by manipulating the reaction rate and/or the reaction time of the roughening process. Referring to Equation 1 previously provided, decreasing the concentration of HF in the roughening solution will decrease the concentration of reactants of Equation 1 and, therefore, decrease the reaction rate of Equation 1, leading to a decrease in the reactants for Equation 2 and a corresponding reduction in the formation of M₂SiF₆. As previously described, decreasing the concentration of M₂SiF₆ in the roughening solution decreases crystal formation as well as crystal growth.

For transparent glass sheets 100 that are aluminosilicate glass sheets, the crystal growth may be further reduced by increasing the concentration of fluoride ions in the roughening solution. The following chemical Equations 3-5 describe the chemical reactions related to etching an aluminosilicate glass:

Al₂O₃+6H⁺→2Al³⁺+3H₂O Eq. 3

HF↔H⁺+F⁻ Eq. 4

F⁻+HF↔HF₂⁻ Eq. 5

In Equation 3, aluminum oxide (Al₂O₃) at the surface of the aluminosilicate glass sheet is etched by protons (H⁺) (i.e., hydronium ions) to form aluminum ions (Al³⁺) and water (H₂O). Equation 4 is the equilibrium dissociation of hydrofluoric acid HF in solution into fluoride ions (F⁻) and hydronium ions (H⁺). Adding fluoride ions, such as by increasing the concentration of ammonium fluoride (NH₄F) in the roughening solution, shifts the equilibrium reaction of Equation 4 to the left towards formation of hydrofluoric acid (HF). Shifting the equilibrium of Equation 4 to the left results in a decrease in the concentration of hydronium ions (H⁺) and, thus, an increase in the pH of the roughening solution. The equilibrium of Equation 4 may further be shifted towards formation of HF through consumption of HF by Equation 5, in which the HF reacts with the increased concentration of fluoride ion (F⁻) to produce hydrogen difluoride ion (HF₂⁻). Consumption of HF decreases the concentration of HF in the roughening solution. As previously described, decreasing the HF concentration decreases the reaction rate of Equation 1, which reduces the crystal formation and crystal growth on the glass surface 101 of the transparent glass sheet 100. Therefore, increasing the fluoride ions (F⁻) by increasing the concentration of NH₄F in the roughening solution may increase the pH of the roughening solution and slow down the reactions resulting in crystal formation and growth.

Crystal growth may be further controlled by adjusting the reaction time (i.e., the time that the glass surface 101 of the transparent glass sheet 100 is maintained in contact with the roughening solution). As reaction time increases, the reactions of Equations 1-5 continue to proceed, resulting in continued crystal growth. Limiting the reaction time results in less crystal growth. The final crystal size, and therefore, the final size of the discrete surface features 104, may be reduced by shortening the reaction time.

Referring to FIGS. 8 and 10D, the acid polishing step 210 may be used to reduce the surface haze value of the anti-glare surface 102. In the acid polishing step 210, the transparent glass sheet 100 may be introduced to a second etching bath that includes an etching solution. In the acid polishing step 210, the etching solution does not include components that promote crystal growth, such as NH₄F or KCL for example. Instead, the etching solutions used for acid polishing may include an aqueous solution of one or more of HF, sulfuric acid (H₂SO₄), hydrochloric acid (HCl), nitric acid (HNO₃), phosphoric acid (H₃PO₄), or other mineral acid, or combinations of these. In the acid polishing step 210, the etching solution (i.e., etchant) removes material from the glass surface 101.

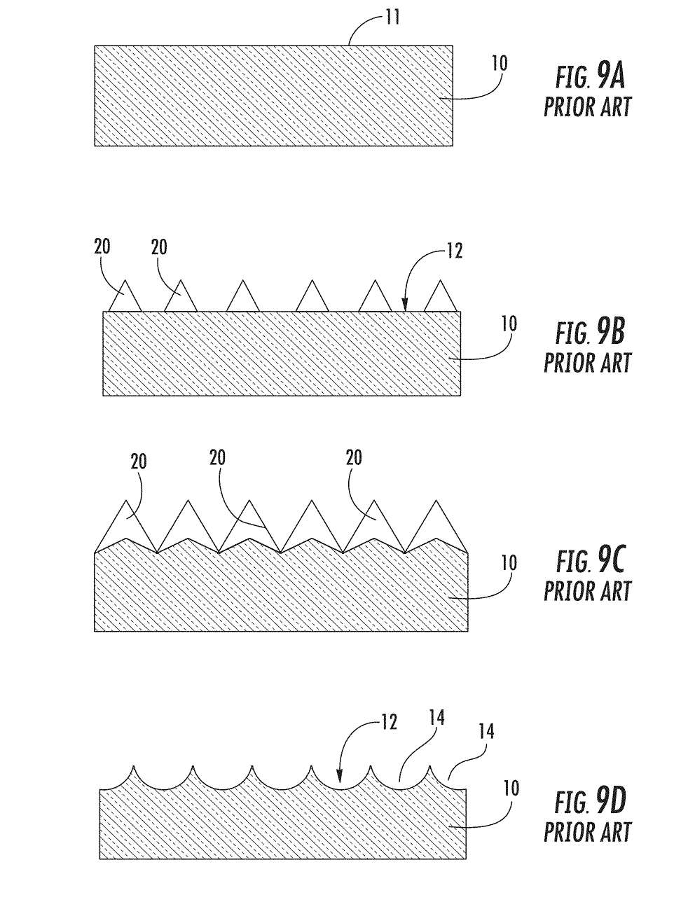

FIGS. 9A-9D depict the stages of forming a conventional anti-glare surface 12 on the glass sheet 10. In FIG. 9A, a glass sheet 10 having a surface 11 is provided. FIGS. 9B and 9C schematically depict formation and growth of crystals 20 on the surface 11 of the glass sheet 10. As shown in FIGS. 9B and 9C, the crystals 20 are seeded and grown to fully cover the entire surface 11 of the glass sheet 10. The continuous network of crystals 20 creates an etching mask across the entire surface 11 of the glass sheet 10. FIG. 9D depicts the glass sheet 10 after the acid polishing step. As shown in FIG. 9D, acid polishing (i.e., chemical etching) imprints the etching mask onto the surface 11 of the glass sheet 10 and generates continuous patterns on the glass sheet 10. During the polishing step, the surface features 14 further grow in size. Though not intending to be limited by theory, it is believed that the acid polishing of the continuous network of surface features 14 causes consolidation of surface features 14 such that the valleys grow deeper, thus increasing the average size of the surface features 14. For example, the etching solution removes material, which may include the contours of smaller surface features 14, from the surface of the glass sheet 10. This may result in an overall increase in the average size of the continuous surface features 14. As the average size of the continuous surface features 14 increases through acid polishing, the sparkle value of the surface 12 of the glass sheet 10 also increases.

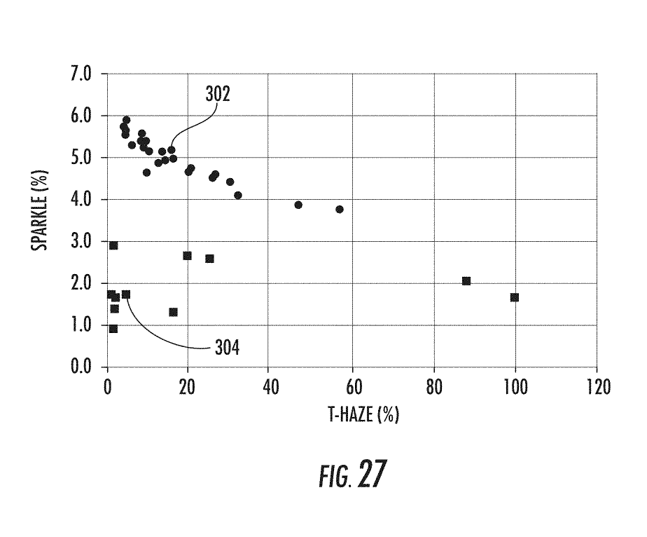

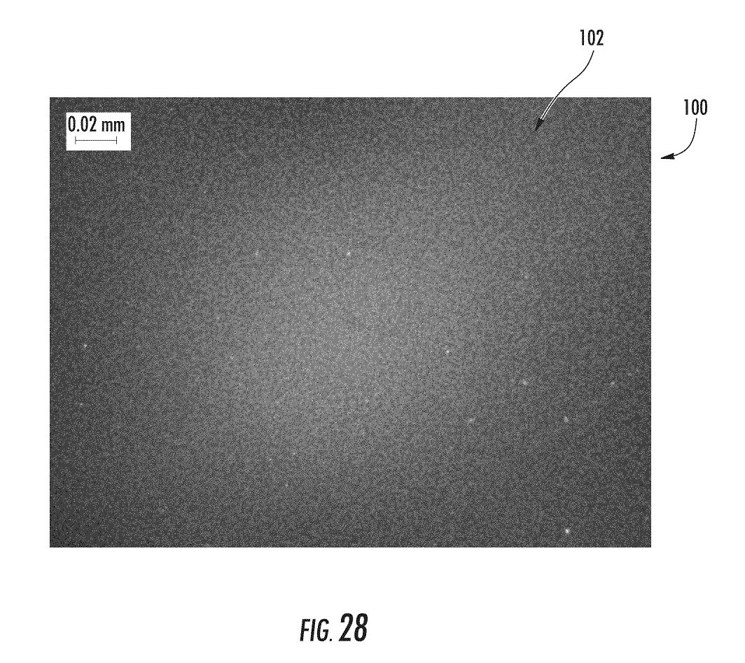

FIG. 27 depicts the sparkle (y-axis) as a function of haze (x-axis) for a plurality of conventional anti-glare surfaces, which are indicated with circles (i.e., first data series 302). As shown in FIG. 27, for the conventional anti-glare surfaces (first data series 302), the sparkle value increases as the haze is reduced through increasing acid polishing. This relationship between sparkle and haze for the conventional anti-glare surfaces suggests that the conventional anti-glare surfaces having continuous surface features are not capable of achieving low haze and low sparkle, simultaneously.

Referring to FIG. 10B-10C, for the method of making the anti-glare surface 102 having discrete surface features 104 separated by flat regions 106, crystal formation and crystal growth are controlled so that the discrete surface features 104 that are formed are spaced apart from one another and only partially cover the glass surface 101 of the transparent glass sheet 100. During the acid polishing step (FIG. 10D), the size of each of the discrete surface features 104 is maintained or reduced. For the anti-glare surface 102, the discrete surface features 104 are separated from one another by the flat regions 106, which may circumscribe each of the discrete surface features 104. The etching solution removes material from each of the discrete surface features 104 making each discrete surface feature 104 smaller. In the flat regions 106 extending around and between each of the discrete surface features 104, the etching solution removes material uniformly from the flat regions 106 of the transparent glass sheet 100, which does not have an effect on the size of each of the discrete surface features 104. The end result is that each of the discrete surface features 104 actually decreases in size during the acid polishing step. Because the discrete surface features 104 are separated from one another, reduction in the size of the smaller sized discrete surface features 104 does not result in consolidation of the discrete surface features 104 into larger features having increased average size. Thus, the average size of each of the discrete surface features 104 stays constant or decreases during acid polishing of the anti-glare surface 102 having discrete surface features 104.

Referring to FIG. 27, the sparkle as a function of haze for a plurality of anti-glare surfaces 102 having discrete surface features 104 separated by flat regions 106 are depicted with square indicators (i.e., second data series 304). As shown in FIG. 26, the inverse relationship between sparkle and haze is not present for the anti-glare surfaces 102 having discrete surface features 104 separated by flat regions 106. The second data series 304 in FIG. 27 indicates that the anti-glare surfaces 102 having discrete surface features 104 separated by flat regions 106 may achieve both low haze and low sparkle.

As previously described, in an alternative embodiment of an anti-glare surface 102 for a transparent glass sheet 100, the plurality of discrete surface features 104 may be a plurality of depressions 110, as shown in FIG. 2B. The plurality of depressions 110 may be formed by a method involving removal of material from the surface 101 of the transparent glass sheet 100 rather than deposition of material on the surface 101 of the transparent glass sheet 100. The alternative method for forming the plurality of depressions 110 may include at least partially destructing the anti-glare surface 102 of the transparent glass sheet 100 to form the plurality of discrete depressions 110. Once the plurality of discrete depressions 110 are initially formed, the anti-glare surface 102 may be acid polished to adjust the size of the depressions 110 to create the target roughness and reduce haze. In one or more embodiments, the plurality of discrete depressions 110 in the anti-glare surface 102 may be made by a sandblasting operation controlled to produce the plurality of discrete surface depressions 110 spaced apart from one another and separated by flat regions 106. In one or more embodiments, a method for producing an anti-glare surface 102 on a transparent glass sheet 100 may include providing a transparent glass sheet 100 having a surface, cleaning the surface of the transparent glass sheet 100, at least partially destructing the surface to produce a plurality of discrete surface features 104, and acid polishing the surface. Destructing the surface may be carried out in a controlled manner to produce the discrete surface features 104 that are spaced apart from one another and separated by one or more flat regions 106 of the anti-glare surface 102 of the transparent glass sheet 100.

Optionally, the transparent glass sheet 100 having the anti-glare surface 102 with the plurality of discrete surface features 104 separated by flat regions 106 may be strengthened using a chemical or thermal strengthening process. In embodiments, the transparent glass sheet 100 may be thermally strengthened. Alternatively, the transparent glass sheet 100 may be chemically strengthened using an ion exchange process to form a strengthened transparent glass sheet having one or more ion exchanged surfaces, for example. In this process, metal ions at or near a surface of the transparent glass sheet 100 are exchanged for larger metal ions having the same valence as the metal ions in the glass. The exchange is generally carried out by contacting the transparent glass sheet 100 with an ion exchange medium such as, for example, a molten salt bath that contains the larger metal ion. The metal ions are typically monovalent metal ions such as, for example, alkali metal ions. In one non-limiting example, chemical strengthening of a glass substrate containing sodium ions by ion exchange is accomplished by immersing the glass substrate in an ion exchange bath comprising a molten potassium salt such as potassium nitrate (KNO₃) for example.

The replacement of small metal ions by larger metal ions in the ion exchange process creates a region in the glass that extends from the surface to a depth (referred to as the “depth of layer”) that is under compressive stress. This compressive stress at the surface of the transparent glass substrate is balanced by a tensile stress (also referred to as “central tension”) within the interior of the glass substrate. In some embodiments, the surface of the transparent glass substrate described herein, when strengthened by an ion exchange process, has a compressive stress of at least 350 MPa, and the region under compressive stress extends to a depth of layer of at least 15 μm below the surface.

The transparent glass sheet 100 having the anti-glare surface 102 that includes the plurality of discrete surface features 104 spaced apart and separated by the flat regions 106, as previously described, may be used as a front cover or cover glass for high definition display devices for an electronic device, such as a consumer electronic device. Examples of high definition display devices may include, but are not limited to, liquid crystal displays (LCD), organic light emitting diode (OLED), touch screens, or the like, having a resolution equal to or greater than 200 ppi in some embodiments, or equal to or greater than 2000 ppi in other embodiments. Examples of consumer electronic devices having high definitions displays with cover glass made from the transparent glass sheet 100 having the anti-glare surface 102 that includes the discrete surface features 104 spaced apart and separated by flat regions 106 may include, but are not limited to, smartphones, tablets, laptop computer displays, monitors, television screens, or other display devices. In one or more embodiments, an electronic device comprises a transparent glass sheet 100 having the anti-glare surface 102 that includes the plurality of discrete surface features 104 spaced apart and separated by the flat regions 106. The electronic device (for example a high definition display device) may a housing having front, back, and side surfaces; electrical components that are at least partially inside or entirely within the housing and including at least a controller, a memory, and a display at or adjacent to the front surface of the housing; and a cover substrate at or over the front surface of the housing such that it is over the display, wherein the cover substrate is any of the glasses disclosed herein.

### Test Methods

Average Size of the Discrete Surface Features

The average size of the discrete surface features 104 may be determined from a photomicrograph of the anti-glare surface 102 of the transparent glass sheet 100 at 200× magnification. Each of the discrete surface features 104 are identified and manually measured. The measurements for each of the discrete surface features 104 in the photomicrograph are averaged together to determine the average size of the discrete surface features 104.

Sparkle Value

SMS Bench

The sparkle value of the anti-glare surfaces 102 may be evaluated using a bench-top Sparkle Measurement System (“SMS Bench”), Version 3.0.3, obtained from Display-Messtachnik & Systeme GmBH and a display light source of 141 ppi. The display light source can be a model Lenovo model Z510 screen. The sparkle values for the anti-glare surfaces disclosed herein using SMS Bench are reported in percent (%).

PPDr Method

The sparkle value of the anti-glare surface 102 may also be evaluated in terms of “pixel power deviation” (PPD). PPD is calculated by image analysis of display pixels according to the following procedure. A grid box is drawn around each LCD pixel. The total power within each grid box is then calculated from the CCD camera data and assigned as the total power tier each pixel. The total power tier each LCD pixel thus becomes an array of numbers, for which the mean and standard deviation may be calculated. The PPD value is defined as the standard deviation of total power per pixel divided by the mean power per pixel (times 100). The total power collected from each LCD pixel by the eye simulator camera is measured and the standard deviation of total pixel power (PPD) is calculated across the measurement area, which typically comprises about 30×30 LCD pixels.

The details of a measurement system and image processing calculation that are used to obtain PPI) values are described in U.S. Pat. No. 9,411,180, granted on Aug. 9, 2016, to Jacques Gollier et al, and entitled “Apparatus and Method fix Determining Sparkle,” the contents of which are incorporated by reference herein in its entirety. The measurement system includes: a pixelated source comprising a plurality of pixels, wherein each of the plurality of pixels has referenced indices i and j; and an imaging system optically disposed along an optical path originating from the pixelated source. The imaging system comprises: an imaging device disposed along the optical path and having a pixelated sensitive area comprising a second plurality of pixels, wherein each of the second plurality of pixels are referenced with indices m and n; and a diaphragm disposed on the optical path between the pixelated source and the imaging device, wherein the diaphragm has an adjustable collection angle for an image originating in the pixelated source. The image processing calculation includes: acquiring; a pixelated image of the transparent sample, the pixelated image comprising a plurality of pixels; determining boundaries between adjacent pixels in the pixelated image; integrating within the boundaries to obtain an integrated energy for each source pixel in the pixelated image; and calculating a standard deviation of the integrated energy for each source pixel, wherein the standard deviation is the power per pixel dispersion.

The light source used for the PPDr method may be a Fiber-Lite® LMI-6000 light source obtained from Dolan-Jenner industries. The mask may be a Part ID 210 ppi custom target on B270 glass obtained from Applied image, Inc. Sparkle values for the anti-glare surfaces disclosed herein using the PPDr method are reported in percent (%).

Transmittance and Haze

The transmittance and transmission haze (or T-haze) values of the anti-glare surfaces may be measured according to ASTM D1003 using a Haze-Guard testing apparatus by Elektron Technologies, PLC. As used herein, the term “transmittance” is defined as the percentage of incident optical power within a given wavelength range transmitted through a material. The transmittance value and the transmission haze value may be reported as percentages (%).

Gloss and Distinctness of Image

The 20° gloss, 60° gloss, 85° gloss, and distinctness of image (DOI) values for the anti-glare surfaces may be measured using a geniophotometer, such as a Rhopoint geniophotometer obtained from Rhopoint Instruments. The gloss values may be measured in accordance with ASTM E430 using the geniophotometer, and the DOI values may be measured in accordance with ASTM D5767. The gloss and DOI values are reported as percentages (%).

Surface Roughness and Skew

The surface roughness (R_{A}) was measured using an interferometer and a sample area of 200 micron by 200 micron. The interferometer used was a ZYGO® NEWVIEW™ 7300 Optical Surface Profiler manufactured by ZYGO® Corporation. The surface roughness is reported as a mean surface roughness.

The skew (R_{SK}) is a measurement of the symmetry of the surface profile of the glass surface relative to a mean line of the surface profile. For surface textures having the same surface roughness (R_{A}), the skew may differentiate between the surface textures according to whether each surface texture is more or less peaked. For example, a negative R_{SK} indicates a surface texture having a plurality of valleys, whereas a positive R_{SK} indicates a predominance of peaks in the surface contour. R_{SK} may be derived from the surface roughness measurements as the third central moment of the roughness amplitude density function.

### EXAMPLES

The embodiments described herein will be further clarified by the following examples. Unless otherwise indicated, the transparent glass sheet 100 for each of the examples was an aluminosilicate glass manufactured by Corning Incorporated having an approximate composition as follows on an oxide basis: 64.62 mol % SiO₂; 5.14 mol % B₂O₃; 13.97 mol % Al₂O₃; 13.79 mol % Na₂O; 2.4 mol % MgO; 0.003 mol % TiO₂; and 0.08 mol % SnO₂.

### Examples 1-8

In Examples 1-8, the effects of changes in composition of the roughening solution and reaction time were investigated. In particular, the concentrations of hydrofluoric acid (HF), ammonium fluoride (NH₄F), and potassium chloride (KCl) were tuned at two levels; a high concentration level and a low concentration level. Eight roughening solutions were prepared, each of the solutions comprising HF, NH₄F, KCl, and water. The concentrations of HF, NH₄F, and KCl for each of the eight roughening solutions prepared for Examples 1-8 are provided in the following Table 1 with the balance of each solution being water. No organic solvents were added to the roughening solution.

TABLE 1
Compositions of Roughening Solutions for Examples 1-8

| Solution | | | |
|---|---|---|---|
| No. | HF (wt. %) | NH₄F (wt. %) | KCl (wt. %) |
| 1 | 3 | 15 | 10 |
| 2 | 3 | 15 | 2 |
| 3 | 3 | 5 | 10 |
| 4 | 3 | 5 | 2 |
| 5 | 6 | 15 | 10 |
| 6 | 6 | 15 | 2 |
| 7 | 6 | 5 | 10 |
| 8 | 6 | 5 | 2 |

To prepare the anti-glare surface 102 on the transparent glass sheet 100, the transparent glass sheet 100 was first cleaned using a cleanline wash. Once cleaned, the transparent glass sheet 100 was introduced to a bath of one of the roughening solutions of Examples 1-8 and maintained in contact with the roughening solution for a reaction time of 1 minute. After 1 minute, the transparent glass sheet 100 was removed from the bath of roughening solution and cleaned with deionized water to remove residual roughening solution from the transparent glass sheet 100. The method was repeated on separate transparent glass sheet 100 samples for each of the eight roughening solutions at a reaction time of 1 minute. A second set of samples were prepared by the same method, but with a reaction time of 8 minutes. None of the samples were subjected to acid polishing prior to evaluation.

Each of the sixteen samples prepared for Examples 1-8 were evaluated for transmittance, transmission haze, gloss 20°, gloss 60°, gloss 85°, distinctness of image (DOI), sparkle, roughness (R_{A}), and skew (R_{SK}), and the results are provided in Table 2 below. The sparkle value for each of the samples of Examples 1-8 was determined using the PPD method previously described. The test results for each of the samples of Examples 1-8 at 1 minute reaction time and 8 minute reaction time are provided in Table 2 below. For the sample ID's in Table 2, the first number before the dash is the solution number and the number after the dash is the reaction time in minutes.

TABLE 2
Performance Properties Measured for Examples 1-8

| | | | 20° | 60° | 85° | | | | |
|---|---|---|---|---|---|---|---|---|---|
| Sample | Transmittance | Haze | Gloss | Gloss | Gloss | DOI | Sparkle | Ra | |
| ID | (%) | (%) | (%) | (%) | (%) | (%) | (%) | (nm) | Rsk |
| 1-1 | 93.4 | 23.6 | 65.8 | 47.0 | 93.2 | 99.6 | 1.18 | 131 | 0.16 |
| 2-1 | 93.4 | 21.5 | 93.0 | 61.5 | 92.1 | 99.6 | 1.52 | 85 | 2.82 |
| 3-1 | 93.2 | 28.1 | 37.6 | 39.5 | 80.4 | 95.7 | 4.01 | 253 | 0.57 |
| 4-1 | 93.7 | 9.8 | 95.9 | 100.4 | 94.5 | 98.1 | 5.52 | 144 | 1.64 |
| 5-1 | 90.6 | 87.6 | 6.9 | 18.8 | 72.8 | 96.4 | 3.98 | 372 | 1.73 |
| 6-1 | 93.6 | 12.7 | 96.4 | 106.2 | 86.2 | 98.6 | 5.67 | 163 | 3.59 |
| 7-1 | 90.8 | 73.7 | 2.1 | 12.0 | 69.3 | 73.6 | 3.38 | 391 | −0.77 |
| 8-1 | 92.9 | 25.6 | 71.0 | 78.9 | 40.1 | 97.5 | 8.01 | 420 | 2.47 |
| 1-8 | 77.5 | 86.7 | 2.6 | 10.6 | 71.6 | 97.3 | 3.14 | 550 | −0.93 |
| 2-8 | 92.5 | 42.7 | 38.8 | 47.2 | 20.3 | 94.0 | 7.83 | 775 | 0.33 |
| 3-8 | 88.9 | 74.9 | 1.5 | 11.2 | 61.6 | 42.7 | 3.48 | 312 | −0.63 |
| 4-8 | 86.6 | 84.6 | 1.1 | 11.6 | 28.9 | 15.5 | 4.26 | 951 | −0.16 |
| 5-8 | 82.6 | 83.1 | 2.5 | 11.5 | 72.0 | 96.1 | 3.29 | 289 | −1.30 |
| 6-8 | 86.6 | 84.1 | 4.2 | 15.3 | 12.2 | 67.9 | 4.87 | 1974 | −0.75 |
| 7-8 | 88.9 | 75.0 | 2.0 | 11.1 | 69.0 | 80.8 | 3.66 | 406 | −0.62 |
| 8-8 | 86.7 | 85.7 | 1.8 | 13.7 | 14.6 | 7.5 | 5.61 | 1372 | 0.74 |

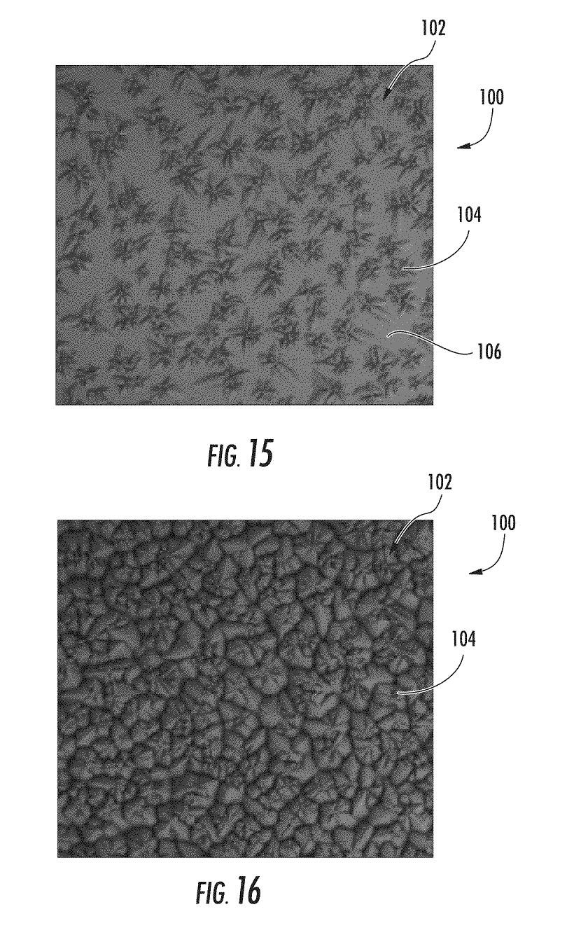

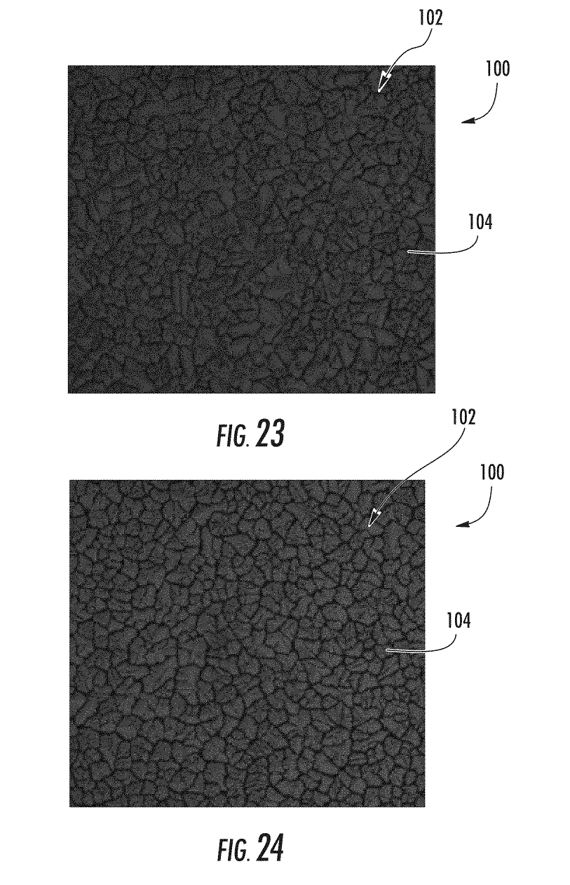

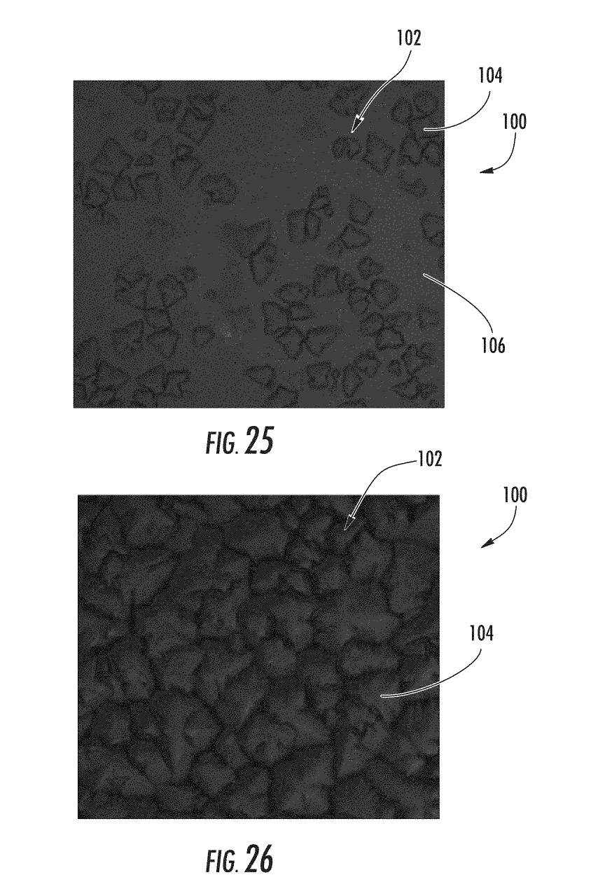

In addition to the evaluations performed and reported in the table above, photomicrographs of the anti-glare surface 102 of each of the samples prepared for Examples 1-8 were taken at a magnification of 200 times and are included in FIGS. 11-26. The following Table 3 provides a cross-reference of the solution ID and reaction time with the photomicrographs in FIGS. 11-26.

TABLE 3
Cross-Reference Between the Samples of Examples 1-8 and FIGS. 10-25

| Sample ID | Solution | Etch Time (min) | FIG. Number |
|---|---|---|---|
| 1-1 | 1 | 1 | 11 |
| 2-1 | 2 | 1 | 13 |
| 3-1 | 3 | 1 | 15 |
| 4-1 | 4 | 1 | 17 |
| 5-1 | 5 | 1 | 19 |
| 6-1 | 6 | 1 | 21 |
| 7-1 | 7 | 1 | 23 |
| 8-1 | 8 | 1 | 25 |
| 1-8 | 1 | 8 | 12 |
| 2-8 | 2 | 8 | 14 |
| 3-8 | 3 | 8 | 16 |
| 4-8 | 4 | 8 | 18 |
| 5-8 | 5 | 8 | 20 |
| 6-8 | 6 | 8 | 22 |
| 7-8 | 7 | 8 | 24 |
| 8-8 | 8 | 8 | 26 |

Qualitative evaluation of the photomicrographs led to the observation that reducing the concentration of KCl in the roughening solution reduces the density of the discrete surface features. FIGS. 11 and 15 are photomicrographs of the samples prepared with solution 1 (Sample ID 1-1) and solution 3 (Sample ID 3-1), respectively, each of solutions 1 and 3 having 10 wt. % KCl. FIGS. 11 and 15 show the anti-glare surface 102 having a high density of the discrete surface feature 104, which are spaced close together. For comparison, FIGS. 13 and 17 are photomicrographs of the samples prepared with solutions 2 (Sample ID 2-1) and solution 4 (Sample ID 4-1), respectively, each of solutions 2 and 4 having only 2 wt. % KCl. The anti-glare surface 102 shown in FIGS. 13 and 17 for solutions 2 and 4 having reduced concentrations of KCl show a lower density of the discrete surface features 104, which are spaced farther apart from each other, as compared to the anti-glare surfaces 102 shown in FIGS. 11 and 15. Thus, reducing the concentration of KCl in the roughening solution is shown to reduce the density of the discrete surface features 104 formed on the anti-glare surface 102 of the transparent glass sheet 100. Each of FIGS. 11, 13, 15, and 17 clearly show each of the plurality of discrete surface features 104 being circumscribed (i.e., completely surrounded) by flat regions 106.

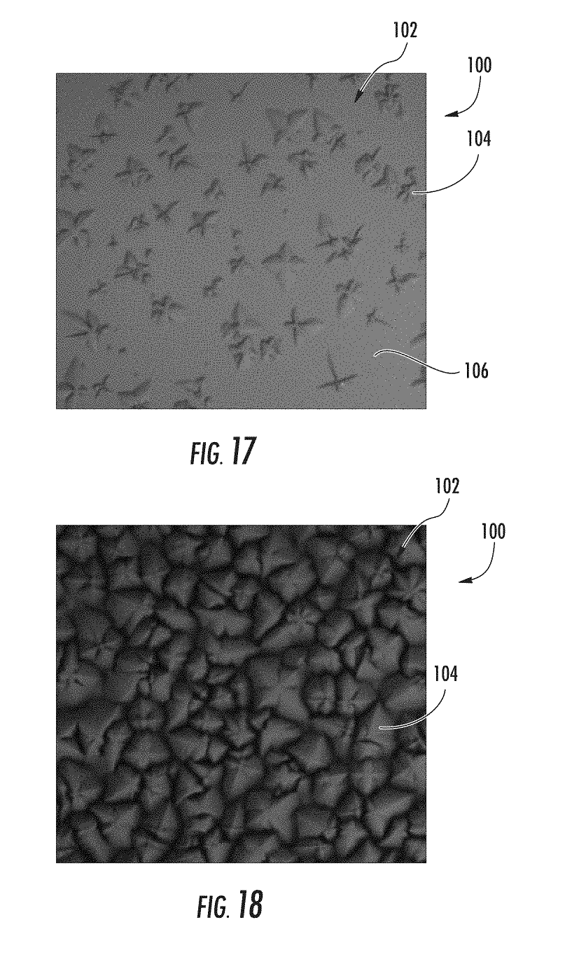

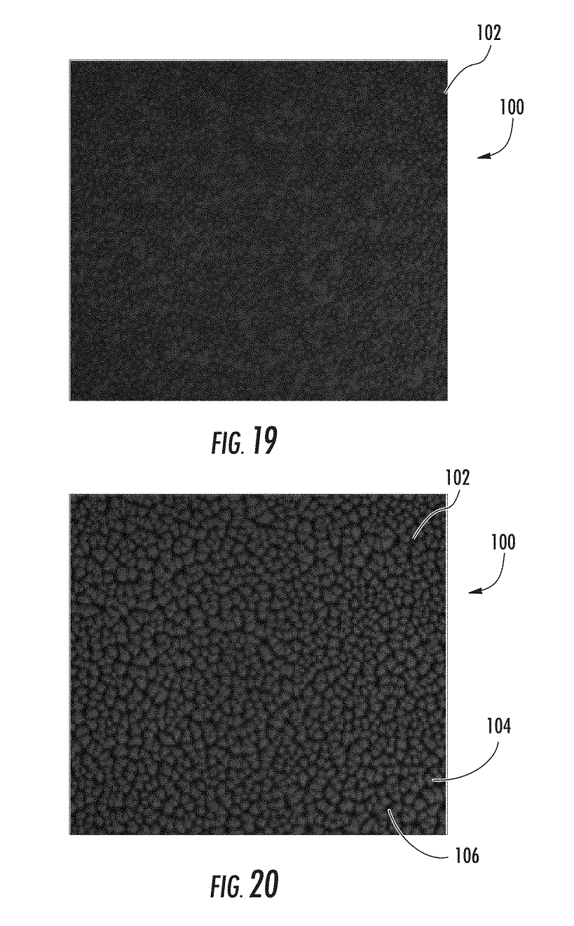

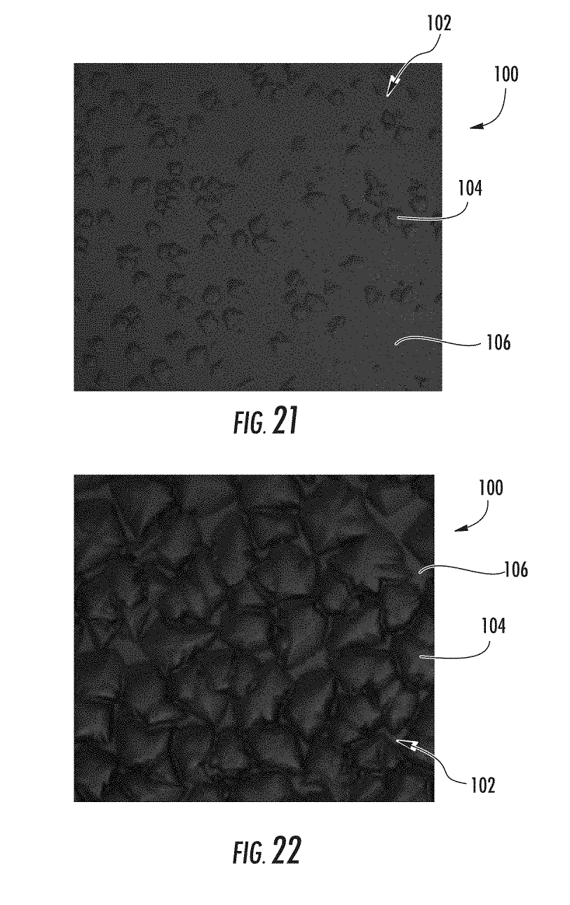

Qualitative evaluation of the photomicrographs also confirmed that increasing the reaction time of the transparent glass sheet 100 with the roughening solution increases the average size of the discrete surface features 104 formed on the anti-glare surface 102. For Example, FIG. 13 is a photomicrograph of the anti-glare surface 102 of Sample ID 2-1 made with roughening solution 2 and having a reaction time of 1 minute, and FIG. 14 is a photomicrograph of the anti-glare surface 102 of Sample ID 2-8 made with the same roughening solution 2 but with a reaction time of 8 minutes. The discrete surface features 104 shown in FIG. 14 are substantially larger than the discrete surface features 104 in FIG. 13. The same observation was made for FIG. 16 relative to FIG. 15, FIG. 18 relative to FIG. 17, FIG. 20 relative to FIG. 19, and FIG. 22 relative to FIG. 21. In FIGS. 16, 18, and 22, in particular, the discrete surface features 104 grew enough to completely cover the anti-glare surface 102 of the transparent glass sheet 100, suggesting that a reaction time of less than 8 minutes using the roughening solutions of Examples 1-8 may be necessary to ensure that the discrete surface features 104 are spaced apart and separated by the flat regions 106.

Further, qualitative evaluation of the photomicrographs led to the observation that increasing the NH₄F concentration slows down the reactions and leads to discrete surface features 104 that are smaller in size. FIGS. 11 and 13 are photomicrographs of the samples prepared with solution 1 (Sample ID 1-1) and solution 2 (Sample ID 2-1), respectively, each of solutions 1 and 1 having 15 wt. % NH₄F. FIGS. 11 and 13 show the anti-glare surface 102 having discrete surface features 104 with a small average size. For comparison, FIGS. 15 and 17 are photomicrographs of the samples prepared with solution 3 (Sample ID 3-1) and solution 4 (Sample ID 4-1), respectively, each of solutions 3 and 4 having only 5 wt. % NH₄F. The anti-glare surfaces 102 shown in FIGS. 15 and 17 for solutions 3 and 4 having reduced concentrations of NH₄F show discrete surface features 104 having a larger average size compared to the discrete surface features 104 shown in FIGS. 11 and 13. Thus, increasing the concentration of NH₄F in the roughening solution is shown to reduce the reaction rate, resulting in formation of discrete surface features 104 having decreased average size.

Sparkle values measured for the Samples in Table 2 above ranged from 1.2% to 8%. As indicated by the results provided above in Table 2, the lowest sparkle values were obtained for Sample ID's 1-1 and 2-1, both of which samples were made with roughening solutions having a lower concentration of HF (3 wt. %) and a higher concentration of NH₄F (15 wt. %) as compared to solutions 3-4, which had lower NH₄F concentrations of only 5 wt. %, and solutions 5-8, which had higher HF concentrations of 6 wt. %.

Further, it was observed that decreasing the concentration of KCl in the roughening solution resulted in an increase in the sparkle measurement of the anti-glare surface 102 of the transparent glass sheet 100. For Example, Sample ID 3-1 was made with solution 3 having 10 wt. % KCl, and Sample ID 4-1 was made with solution 4 having a reduced concentration of KCl of 2 wt. %. The sparkle measurement for Sample ID 4-1 was higher than the sparkle measurement for Sample ID 3-1, which had the greater concentration of KCl. Similar relationships were observed between Sample ID's 5-1 and 6-1, Samples ID's 7-1 and 8-1, Sample ID's 1-8 and 2-8, Sample ID's 3-8 and 4-8, Sample ID's 5-8 and 6-8, and Sample ID's 7-8 and 8-8. Thus, the sparkle measurements indicate that increasing the KCl concentration in the roughening solution tends to decrease the sparkle of the resulting anti-glare surface 102 of the transparent glass sheet 100.

Additionally, the surface roughness of the anti-glare surface 102 of the transparent glass sheet 100 increased substantially when the reaction time was increased from 1 minute to 8 minutes.

### Examples 9-14

The objective of Examples 9-14 was to use the relationships observed in Examples 1-8 to make anti-glare surfaces 102 having discrete surface features 104 spaced apart and separated by flat regions 106, the anti-glare surface 102 exhibiting low sparkle values. Consistent with the observations of Examples 1-8, the solutions of Examples 9-14 included lesser concentrations of HF (e.g., 1 wt. % and 3 wt. %) and greater concentrations of NH₄F (15 wt. %). The reactions times were also shortened relative to the method used in Examples 1-8. In Examples 9-14, the effects of changes in composition of the roughening solution and reaction time were further tuned. In particular, the concentrations of HF and KCl were tuned at two levels; a high concentration level and a low concentration level. The concentration of NH₄F was maintained constant at 15 wt. %. Six roughening solutions were prepared, each of the solutions comprising HF, NH₄F, KCl, and water. In Examples 13 and 14, propylene glycol was added at a volume concentration of 15 volume % (vol. %) to study the effects of adding a quantity of organic solvent to the roughening solution. The concentrations of HF, NH₄F, KCl, and propylene glycol for each of the six roughening solutions prepared for Examples 9-14 are provided in the following Table 4 with the balance of each solution being water.

TABLE 4
Compositions of Roughening Solutions for Examples 9-14

| Solution | | | | Propylene |
|---|---|---|---|---|
| No. | HF (wt. %) | NH₄F (wt. %) | KCl (wt. %) | Glycol (vol. %) |
| 9 | 1 | 15 | 10 | 0 |
| 10 | 1 | 15 | 20 | 0 |
| 11 | 3 | 15 | 10 | 0 |
| 12 | 3 | 15 | 20 | 0 |
| 13 | 1 | 15 | 10 | 15 |
| 14 | 1 | 15 | 20 | 15 |

To prepare the anti-glare surface 102 on the transparent glass sheet 100 for Examples 9-14, the transparent glass sheet 100 was first cleaned using a cleanline wash. Once cleaned, a transparent glass sheet 100 was introduced to a bath of one of the six roughening solutions of Examples 9-14 and maintained in contact with the roughening solution for a reaction time of 1 minute. After 1 minute, the transparent glass sheet 100 was removed from the bath of roughening solution and cleaned with deionized water to remove residual roughening solution from the transparent glass sheet 100. The method was repeated on separate transparent glass sheet 100 samples for each of the six roughening solutions at a reaction time of 1 minute. A second set of transparent glass sheet 100 samples were prepared by the same method, but with a reaction time of 4 minutes. None of the samples were subjected to acid polishing prior to evaluation.

Each of the twelve total samples prepared for Examples 9-14 were evaluated for transmittance, haze, gloss 20°, gloss 60°, gloss 85°, DOI, sparkle, roughness (R_{A}), and skew (R_{SK}), and the results are provided in Table 5 below. The sparkle value for each of the samples of Examples 9-14 was measured by SMS Bench using a 141 ppi light source. The test results for each of the twelve samples of Examples 9-14, six samples at the 1 minute reaction time and 6 samples at the 4 minute reaction time, are provided in Table 5 below. For the sample ID's in Table 5, the first number before the dash is the solution number and the number after the dash is the reaction time in minutes.

TABLE 5
Performance Properties Measured for Examples 9-14

| | | | 20° | 60° | 85° | | | | |
|---|---|---|---|---|---|---|---|---|---|
| Sample | Transmittance | Haze | Gloss | Gloss | Gloss | DOI | Sparkle | Ra | |
| ID | (%) | (%) | (%) | (%) | (%) | (%) | (%) | (nm) | Rsk |
| 9-1 | 94.7 | 4.6 | 71.7 | 103.7 | 109.1 | 99.7 | 1.7 | 5.0 | −0.181 |
| 9-4 | 93.5 | 25.2 | 8.3 | 9.3 | 67.7 | 99.0 | 2.6 | 281.1 | −0.121 |
| 10-1 | 95.3 | 1.4 | 98.9 | 119.3 | 114.5 | 99.7 | 0.9 | 4.5 | −0.133 |
| 10-4 | 97.1 | 1.6 | 50.2 | 97.5 | 112.2 | 99.5 | 2.9 | 6.6 | 1.308 |
| 11-1 | 85.3 | 100.0 | 1.9 | 2.3 | 24.2 | 92.4 | 1.6 | 784.6 | 0.397 |
| 11-4 | 88.7 | 88.3 | 18.7 | 8.5 | 19.8 | 98.8 | 2.0 | 328.8 | 0.920 |
| 12-1 | 94.9 | 16.1 | 9.8 | 15.7 | 83.5 | 99.4 | 1.3 | 25.9 | −0.729 |
| 12-4 | 94.9 | 19.4 | 5.0 | 6.1 | 73.0 | 99.2 | 2.7 | 44.0 | −0.098 |
| 13-1 | 93.8 | 2.1 | 113.2 | 119.3 | 115.0 | 99.6 | 1.7 | 1.4 | 0.338 |
| 13-4 | 96.4 | 1.8 | 52.0 | 95.5 | 112.5 | 99.5 | 1.4 | 4.0 | −0.350 |
| 14-1 | 94.5 | 0.9 | 127.8 | 119.3 | 117.4 | 99.6 | 1.7 | 0.9 | −0.066 |
| 14-4 | 97.1 | 1.8 | 35.3 | 64.6 | 106.4 | 99.5 | 2.9 | 4.0 | −0.542 |

As indicated in Table 4, the anti-glare surfaces 102 of the samples prepared for Examples 9-14 exhibited sparkle values less than 3%, in particular, the sparkle values for Examples 9-14 were in a range of 0.9 to 2.9. FIG. 27 shows a graph of the sparkle values for Examples 9-14 (second data series 304 indicated by squares). For comparison, FIG. 27 includes sparkle and transmission haze data for a plurality of glass sheets 10 (FIG. 1A) having conventional anti-glare surfaces 12 having continuous texture features 14 (first data series 302 indicated by circles). The plot of sparkle and transmission haze data for glass sheets 10 having the conventional anti-glare surfaces 12 (first data series 302) indicates an inverse relationship between haze and sparkle. As shown in FIG. 27, decreasing the transmission haze of the conventional anti-glare surface 12 results in an increase in the sparkle value. Because of this apparent relationship, a conventional anti-glare surface 12 with continuous texture features 14 generally cannot be made to have both low haze and low sparkle. In contrast, the several of the transparent glass sheets 100 of Examples 9-14 (second data series 304), which have an anti-glare surface 102 with discrete surface features 104 spaced apart and separated by flat regions 106, exhibited both a low haze value of less than 20% and a low sparkle value of less than 3%. This shows that for an anti-glare surface 102 having discrete surface features 104 that are spaced apart and separated by flat regions 106, the sparkle is independent of the haze. Therefore, the haze and the sparkle may be tuned independently for anti-glare surfaces 102 having discrete surface features 104. Low haze and low sparkle similar to those observed for Examples 9-14 are not achievable by conventional anti-glare surfaces 12 having continuous surface features 14.

FIG. 28 is a photomicrograph at 500× magnification of the anti-glare surface 102 of the transparent glass sheet 100 of Example 9 made with a reaction time of 1 minute (Sample ID 9-1). As observed in FIG. 28, the discrete surface features 104 have an average size less than 1 micron. The measured sparkle for the anti-glare surface 102 of the transparent glass sheet 100 of FIG. 28 was 1.7%.

Based on the foregoing, it should now be understood that the embodiments described herein relate to transparent glass sheets 100 having anti-glare surfaces 102 with discrete surface features 104 that result in low sparkle values. The transparent glass sheets 100 and anti-glare surfaces 102 described herein may provide an anti-glare surface 102 with low sparkle and low haze that may be used as cover glass for high definition displays incorporated into consumer electronic devices.

While various embodiments of the anti-glare surface 102 and techniques for producing the anti-glare surface 102 having the plurality of discrete surface features 104 have been described herein, it should be understood it is contemplated that each of these embodiments and techniques may be used separately or in conjunction with one or more embodiments and techniques.

In a first aspect, a transparent glass sheet comprises at least one anti-glare surface having a plurality of discrete surface features having an average size equal to or less than 20 microns and one or more flat regions, wherein at least a portion of the plurality of discrete surface features are spaced apart from one another and each of the plurality of discrete surface features are bounded by the one or more flat regions, wherein the transparent glass sheet has a sparkle of equal to or less than 3% as evaluated by an SMS bench tester using a display light source of 141 ppi.

A second aspect according to the first aspect, wherein the plurality of discrete surface features are protrusions extending outward from the at least one anti-glare surface.

A third aspect according to the first aspect, wherein the plurality of discrete surface features are depressions in the at least one anti-glare surface.

A fourth aspect according to any previous aspect, wherein an average size of the plurality of discrete surface features is 10 microns or less.

A fifth aspect according to any previous aspect, wherein a majority of the plurality of discrete surface features are spaced apart from one another and separated by the one or more flat regions.

A sixth aspect according to any previous aspect, wherein each of the plurality of discrete surface features are separated from one another by one or more flat regions.

A seventh aspect according to any previous aspect, wherein the one or more flat regions extend between each of the plurality of discrete surface features.

An eighth aspect according to any previous aspect, wherein a majority of the discrete surface features are circumscribed by the one or more flat regions.

A ninth aspect according to any previous aspect, wherein a majority of the one or more flat regions are contiguous.

A tenth aspect according to any previous aspect, wherein the one or more flat regions are interconnected to form a contiguous flat region.

An eleventh aspect according to any previous aspect, wherein any line, which is in a plane of the anti-glare surface, extending from one of the plurality of discrete surface features to another one of the discrete surface features passes through at least one of the one or more flat regions.

A twelfth aspect according to any previous aspect, wherein an area of the one or more flat regions is from 10% to 60% of the total surface area of the anti-glare surface.

A thirteenth aspect according to any previous aspect, wherein an area of the flat regions is from 15% to 50% of the total surface area of the anti-glare surface.

A fourteenth aspect according to any previous aspect, wherein the at least one anti-glare surface has a surface roughness (Ra) from 10 nm to 1000 nm.

A fifteenth aspect according to any previous aspect, wherein the at least one anti-glare surface has a surface roughness (Ra) of from 10 nm to 200 nm.

A sixteenth aspect according to any previous aspect, wherein the transparent glass sheet comprises a transmission haze of less than 20% measured according to ASTM D1003.

A seventeenth aspect according to any previous aspect, wherein the transparent glass sheet comprises a strengthened transparent glass sheet.

An eighteenth aspect according to the seventeenth aspect, wherein the strengthened transparent glass sheet comprises one or more ion-exchanged surfaces.

In a nineteenth aspect, an electronic device comprises: a housing having a front surface, a back surface and side surfaces; electrical components provided at least partially within the housing, the electrical components including at least a controller, a memory, and a display, the display being provided at or adjacent the front surface of the housing; and the glass of any preceding aspect disposed over the display.

In a twentieth aspect, a method for producing an anti-glare surface on a transparent glass sheet, comprises: introducing a roughening solution to a surface of the transparent glass sheet, the roughening solution comprising: from 1 wt. % to 6 wt. % hydrofluoric acid; from 5 wt. % to 15 wt. % ammonium fluoride; and from 2 wt. % to 20 wt. % potassium chloride; maintaining the roughening solution in contact with the surface of the transparent glass sheet to form and grow a plurality of discrete surface features on the surface of the transparent glass sheet; and removing the roughening solution from the surface of the transparent glass sheet before the plurality of discrete surface features grow to fill the entire surface of the transparent glass sheet, wherein upon removal of the roughening solution, the transparent glass sheet comprises the plurality of discrete surface features separated from one another by one or more flat regions.

A twenty first aspect according to the twentieth aspect, further comprising acid polishing the surface of the transparent glass sheet to reduce a transmission haze of the transparent glass sheet and a size of the plurality of the discrete surface features.

A twenty second aspect according to the twentieth or twenty first aspect, wherein the surface of the transparent glass sheet is maintained in contact with the roughening solution for a reaction time equal to or greater than 1 minute and equal to or less than 8 minutes.

A twenty third aspect according to any one of the twentieth through twenty second aspects, further comprising strengthening the transparent glass sheet.

A twenty fourth aspect according to the twenty third aspect, wherein the transparent glass sheet is thermally strengthened.

A twenty fifth aspect according to the twenty third aspect, wherein the transparent glass sheet is chemically strengthened.

In a twenty sixth aspect, a transparent glass sheet has an anti-glare surface treatment prepared by the method of any one of the twentieth through twenty fifth aspects.

A twenty seventh aspect according to the twenty sixth aspect, wherein the plurality of discrete surface features have an average size of 10 microns or less.

A twenty eight aspect according to the twenty sixth or twenty seventh aspect, wherein the transparent glass sheet has a sparkle of 3% or less as evaluated by SMS bench using a display light source of 141 ppi, and a transmission haze of equal to or less than 20% measured according to ASTM D1003.

It will be apparent to those skilled in the art that various modifications and variations can be made to the embodiments described herein without departing from the spirit and scope of the claimed subject matter. Thus it is intended that the specification cover the modifications and variations of the various embodiments described herein provided such modification and variations come within the scope of the appended claims and their equivalents.

1. A transparent glass sheet comprising at least one anti-glare surface having a plurality of discrete surface features having an average size equal to or less than 20 microns and one or more flat regions, wherein at least a portion of the plurality of discrete surface features are spaced apart from one another and each of the plurality of discrete surface features are bounded by the one or more flat regions, wherein the transparent glass sheet has a sparkle of equal to or less than 3% as evaluated by an SMS bench tester using a display light source of 141 ppi.

2. The transparent glass sheet of claim 1, wherein the plurality of discrete surface features are protrusions extending outward from the at least one anti-glare surface.

3. The transparent glass sheet of claim 1, wherein the plurality of discrete surface features are depressions in the at least one anti-glare surface.

4. The transparent glass sheet of claim 1, wherein an average size of the plurality of discrete surface features is 10 microns or less.

5. The transparent glass sheet of claim 1, wherein a majority of the plurality of discrete surface features are spaced apart from one another and separated by the one or more flat regions.

6. The transparent glass sheet of claim 1, wherein each of the plurality of discrete surface features are separated from one another by one or more flat regions.

7. The transparent glass sheet of claim 1, wherein the one or more flat regions extend between each of the plurality of discrete surface features.

8. The transparent glass sheet of claim 1, wherein a majority of the discrete surface features are circumscribed by the one or more flat regions.

9. The transparent glass sheet of claim 1, wherein a majority of the one or more flat regions are contiguous.

10. The transparent glass sheet of claim 1, wherein the one or more flat regions are interconnected to form a contiguous flat region.

11. The transparent glass sheet of claim 1, wherein any line, which is in a plane of the anti-glare surface, extending from one of the plurality of discrete surface features to another one of the discrete surface features passes through at least one of the one or more flat regions.

12. The transparent glass sheet of claim 1, wherein an area of the one or more flat regions is from 10% to 60% of the total surface area of the anti-glare surface.

13. The transparent glass sheet of claim 1, wherein an area of the flat regions is from 15% to 50% of the total surface area of the anti-glare surface.

14. The transparent glass sheet of claim 1, wherein the at least one anti-glare surface has a surface roughness (Ra) from 10 nm to 1000 nm.

15. The transparent glass sheet of claim 1, wherein the at least one anti-glare surface has a surface roughness (Ra) of from 10 nm to 200 nm.

16. The transparent glass sheet of claim 1, wherein the transparent glass sheet comprises a transmission haze of less than 20% measured according to ASTM D1003.

17. The transparent glass sheet of claim 1, wherein the transparent glass sheet comprises a strengthened transparent glass sheet.

18. The transparent glass sheet of claim 17, wherein the strengthened transparent glass sheet comprises one or more ion-exchanged surfaces.

19. An electronic device comprising:
a housing having a front surface, a back surface and side surfaces;
electrical components provided at least partially within the housing, the electrical components including at least a controller, a memory, and a display, the display being provided at or adjacent the front surface of the housing; and
the glass of claim 1 disposed over the display.

20. A method for producing an anti-glare surface on a transparent glass sheet, the method comprising:
introducing a roughening solution to a surface of the transparent glass sheet, the roughening solution comprising:
from 1 wt. % to 6 wt. % hydrofluoric acid;
from 5 wt. % to 15 wt. % ammonium fluoride; and
from 2 wt. % to 20 wt. % potassium chloride;
maintaining the roughening solution in contact with the surface of the transparent glass sheet to form and grow a plurality of discrete surface features on the surface of the transparent glass sheet; and
removing the roughening solution from the surface of the transparent glass sheet before the plurality of discrete surface features grow to fill the entire surface of the transparent glass sheet, wherein upon removal of the roughening solution, the transparent glass sheet comprises the plurality of discrete surface features separated from one another by one or more flat regions.

21. The method of claim 20, further comprising acid polishing the surface of the transparent glass sheet to reduce a transmission haze of the transparent glass sheet and a size of the plurality of the discrete surface features.

22. The method of claim 20, wherein the surface of the transparent glass sheet is maintained in contact with the roughening solution for a reaction time equal to or greater than 1 minute and equal to or less than 8 minutes.

23. The method of claim 20, further comprising strengthening the transparent glass sheet.

24. The method of claim 23, wherein the transparent glass sheet is thermally strengthened.

25. The method of claim 23, wherein the transparent glass sheet is chemically strengthened.

26. A transparent glass sheet having an anti-glare surface treatment prepared by the method of claim 20.

27. The transparent glass sheet of claim 26, wherein the plurality of discrete surface features have an average size of 10 microns or less.

28. The transparent glass sheet of claim 26, wherein the transparent glass sheet has a sparkle of 3% or less as evaluated by SMS bench using a display light source of 141 ppi, and a transmission haze of equal to or less than 20% measured according to ASTM D1003.
